(19) United States
(12) Patent Application Publication
(10) Pub. No.: US 2026/0142696 A1
(43) Pub. Date: May 21, 2026

(54) SPINAL CODING SCHEMES FOR MULTIPLE INPUT MULTIPLE OUTPUT WIRELESS COMMUNICATIONS

(71) Applicant: QUALCOMM Incorporated, San Diego, CA (US)

(72) Inventors: Matan GUETTA, San Diego, CA (US); Peer BERGER, Hod Hasharon (IL); Gideon Shlomo KUTZ, Ramat Hasharon (IL)

(21) Appl. No.: 18/949,367

(22) Filed: Nov. 15, 2024

(51) Int. Cl. H04B 7/0456

(52) U.S. Cl. CPC H04B 7/0456

(57) ABSTRACT

Various aspects of the present disclosure generally relate to wireless communication. Some aspects more specifically relate to multiple input multiple output (MIMO) spinal code encoding schemes. In some aspects, a transmitter may encode a message in accordance with configuration information associated with a MIMO spinal code encoding scheme, resulting in a vector that includes multiple spinal symbols. The transmitter may further map the multiple spinal symbols to multiple transmit antennas, such as by distributing the multiple spinal symbols across multiple layers associated with the multiple transmit antennas and across one or more resource elements (REs) in accordance with the configuration information. The transmitter may transmit, using the multiple transmit antennas and the one or more REs, and a receiver may receive, using multiple receive antennas and the one or more REs, the multiple spinal symbols.

### FIELD OF THE DISCLOSURE

Aspects of the present disclosure generally relate to wireless communication and specifically relate to techniques, apparatuses, and methods associated with spinal coding schemes for multiple input multiple output wireless communications.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method for wireless communication by a transmitter. The method may include encoding a message in accordance with configuration information associated with a multiple input multiple output (MIMO) spinal code encoding scheme, resulting in a vector that includes multiple spinal symbols, where the configuration information includes an indication of one or more parameters associated with the MIMO spinal code encoding scheme and an indication of one or more resource elements (REs) for communicating using the MIMO spinal code encoding scheme. The method may include mapping the multiple spinal symbols to multiple transmit antennas associated with the transmitter, where mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme. The method may include transmitting, using the multiple transmit antennas and the one or more REs, the multiple spinal symbols.

Some aspects described herein relate to a method for wireless communication by a receiver. The method may include receiving, using multiple receive antennas and one or more REs, multiple spinal symbols, where the multiple spinal symbols are associated with a message that is encoded in accordance with configuration information associated with a MIMO spinal code encoding scheme, resulting in a vector that includes the multiple spinal symbols, and where the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme. The method may include decoding the multiple spinal symbols, resulting in multiple message bits associated with the message.

Some aspects described herein relate to a transmitter for wireless communication. The transmitter may include a processing system that includes one or more processors, and one or more memories coupled with the one or more processors. The processing system may be configured to cause the transmitter to encode a message in accordance with configuration information associated with a MIMO spinal code encoding scheme, resulting in a vector that includes multiple spinal symbols, where the configuration information includes an indication of one or more parameters associated with the MIMO spinal code encoding scheme and an indication of one or more REs for communicating using the MIMO spinal code encoding scheme. The processing system may be configured to cause the transmitter to map the multiple spinal symbols to multiple transmit antennas associated with the transmitter, where mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme. The processing system may be configured to cause the transmitter to transmit, using the multiple transmit antennas and the one or more REs, the multiple spinal symbols.

Some aspects described herein relate to a receiver for wireless communication. The receiver may include a processing system that includes one or more processors, and one or more memories coupled with the one or more processors. The processing system may be configured to cause the receiver to receive, using multiple receive antennas and REs, multiple spinal symbols, where the multiple spinal symbols are associated with a message that is encoded in accordance with configuration information associated with a MIMO spinal code encoding scheme, resulting in a vector that includes the multiple spinal symbols, and where the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme. The processing system may be configured to cause the receiver to decode the multiple spinal symbols, resulting in multiple message bits associated with the message.

Some aspects described herein relate to a non-transitory computer-readable medium that stores a set of instructions for wireless communication by a transmitter. The set of instructions, when executed by one or more processors of the transmitter, may cause the transmitter to encode a message in accordance with configuration information associated with a MIMO spinal code encoding scheme, resulting in a vector that includes multiple spinal symbols, where the configuration information includes an indication of one or more parameters associated with the MIMO spinal code encoding scheme and an indication of one or more REs for communicating using the MIMO spinal code encoding scheme. The set of instructions, when executed by one or more processors of the transmitter, may cause the transmitter to map the multiple spinal symbols to multiple transmit antennas associated with the transmitter, where mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme. The set of instructions, when executed by one or more processors of the transmitter, may cause the transmitter to transmit, using the multiple transmit antennas and the one or more REs, the multiple spinal symbols.

Some aspects described herein relate to a non-transitory computer-readable medium that stores a set of instructions for wireless communication by a receiver. The set of instructions, when executed by one or more processors of the receiver, may cause the receiver to receive, using multiple receive antennas and one or more REs, multiple spinal symbols, where the multiple spinal symbols are associated with a message that is encoded in accordance with configuration information associated with a MIMO spinal code encoding scheme, resulting in a vector that includes the multiple spinal symbols, and where the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme. The set of instructions, when executed by one or more processors of the receiver, may cause the receiver to decode the multiple spinal symbols, resulting in multiple message bits associated with the message.

Some aspects described herein relate to an apparatus for wireless communication. The apparatus may include means for encoding a message in accordance with configuration information associated with a MIMO spinal code encoding scheme, resulting in a vector that includes multiple spinal symbols, where the configuration information includes an indication of one or more parameters associated with the MIMO spinal code encoding scheme and an indication of one or more REs for communicating using the MIMO spinal code encoding scheme. The apparatus may include means for mapping the multiple spinal symbols to multiple transmit antennas associated with the apparatus, where the means for mapping the multiple spinal symbols to the multiple transmit antennas includes means for distributing the multiple spinal symbols across multiple layers associated with the multiple transmit antennas and across the one or more REs in accordance with the one or more parameters associated with the MIMO spinal code encoding scheme. The apparatus may include means for transmitting, using the multiple transmit antennas and the one or more REs, the multiple spinal symbols.

Some aspects described herein relate to an apparatus for wireless communication. The apparatus may include means for receiving, using multiple receive antennas and one or more REs, multiple spinal symbols, where the multiple spinal symbols are associated with a message that is encoded in accordance with configuration information associated with a MIMO spinal code encoding scheme, resulting in a vector that includes the multiple spinal symbols, and where the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme. The apparatus may include means for decoding the multiple spinal symbols, resulting in multiple message bits associated with the message.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example associated with encoding of spinal codes in accordance with the present disclosure.

FIG. 4 is a diagram illustrating an example associated with a puncturing scheme for spinal codes in accordance with the present disclosure.

FIGS. 5A-5C are diagrams of examples associated with spinal coding schemes for multiple input multiple output (MIMO) wireless communications in accordance with the present disclosure.

FIG. 6 is a flowchart illustrating an example process performed, for example, at a transmitter or an apparatus of a transmitter that supports MIMO spinal code encoding schemes in accordance with the present disclosure.

FIG. 7 is a flowchart illustrating an example process performed, for example, at a receiver or an apparatus of a receiver that supports MIMO spinal code encoding schemes in accordance with the present disclosure.

FIG. 8 is a diagram of an example apparatus for wireless communication that supports MIMO spinal code encoding schemes in accordance with the present disclosure.

FIG. 9 is a diagram of an example apparatus for wireless communication that supports MIMO spinal code encoding schemes in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Binary coding schemes involve separately encoding and modulating a communication. Various types of binary codes are used in telecommunications. For example, New Radio (NR) physical downlink shared channel (PDSCH) uses binary low-density parity check (LDPC) code, NR physical downlink control channel (PDCCH) uses binary polar code, Long Term Evolution (LTE) PDSCH uses binary turbo code, LTE PDCCH uses binary convolution code, and so forth. However, binary codes can be less spectrally efficient than non-binary coding schemes, particularly for short block lengths. Non-binary codes, which involve jointly encoding and modulating a communication, offer an attractive tradeoff between performance and complexity.

Spinal codes are a class of Euclidean codes, which are typically rateless codes that can handle time-varying channel conditions without requiring explicit bit rate selection. Spinal codes involve transmission at a higher rate than a channel can sustain followed by iterative retransmission of information bits to lower the effective rate until a decoding success occurs (for example, until the receiver transmits an acknowledgment (ACK) or a negative acknowledgment (NACK)). More specifically, the transmitter may perform the encoding once, and the channel rate may be changed based at least in part on the total quantity of channel uses (for example, a total quantity of times a communication channel is utilized to transmit information, which, in some examples, corresponds to a total quantity of REs) (by contrast, in other coding schemes, changing the channel rate is considered to be part of re-encoding the data).

In some examples, wireless communication systems employing spinal codes may be limited to single input single output (SISO)-based communications. This is because current wireless communication standards, such as standards promulgated by the Third Generation Partnership Project (3GPP), may not provide signaling support for other types of spinal-code-based communications, such as multiple input multiple output (MIMO)-based transmissions or the like. Moreover, a decoding complexity traditionally associated with certain spinal code encoding schemes may make spinal codes unattractive for wireless communication systems. Accordingly, spinal codes may have limited applicability in current wireless communication systems in which MIMO-based communications are becoming ubiquitous.

Various aspects relate generally to spinal coding schemes for wireless communications. Some aspects more specifically relate to MIMO spinal code encoding schemes. In some aspects, a transmitter (for example, a network node or a user equipment (UE), among other examples) may encode a message in accordance with configuration information associated with a MIMO spinal code encoding scheme, resulting in a vector that includes multiple spinal symbols. The configuration information may include an indication of one or more parameters associated with the MIMO spinal code encoding scheme (for example, a message length associated with a spinal encoder, a chunk length associated with the spinal encoder, a number of bits on each symbol associated with the spinal encoder, a MIMO puncturing scheme associated with transmitting spinal symbols generated by the spinal encoder, and/or similar parameters) and an indication of one or more resource elements (REs) for communicating using the MIMO spinal code encoding scheme. The transmitter may further map the multiple spinal symbols to multiple transmit antennas, such as by distributing the multiple spinal symbols across multiple layers associated with the multiple transmit antennas and across the one or more REs in accordance with the one or more parameters associated with the MIMO spinal code encoding scheme. The transmitter may transmit, using the multiple transmit antennas and the one or more REs, and a receiver (for example, a network node or a UE, among other examples) may receive, using multiple receive antennas and the one or more REs, the multiple spinal symbols.

In some aspects, the configuration information may indicate a MIMO puncturing scheme associated with the MIMO spinal code encoding scheme and/or the multiple spinal symbols may be distributed across the multiple layers associated with the multiple transmit antennas and across the one or more REs in accordance with the MIMO puncturing scheme. For example, the MIMO spinal code encoding scheme may be associated with multiple spines, and the MIMO puncturing scheme may indicate from which spines, of the multiple spines, spinal symbols are to be transmitted and how to map transmitted spinal symbols to the multiple layers and the one or more REs. In some aspects, the MIMO puncturing scheme may be associated with selectively transmitting spinal symbols associated with fewer than all spines of multiple spines associated with the MIMO spinal code encoding scheme. In some other aspects, the MIMO puncturing scheme may be associated with transmitting one or more redundant spinal symbols (e.g., transmitting multiple spinal symbols for at least one spine). In some other aspects, the MIMO puncturing scheme may be associated with transmitting a first quantity of spinal symbols associated with a first spine and transmitting a second quantity of spinal symbols associated with a second spine, with the first quantity differing from the second quantity.

Particular aspects of the subject matter described in this disclosure can be implemented to realize one or more of the following potential advantages. In some examples, the described techniques can be used to enable the use of spinal codes in MIMO-based communications, which may exhibit increased adaptability to varying channel conditions as compared to LDPC codes and/or polar codes. More particularly, due to a rateless property of some spinal codes (for example, a property associated with the spinal code enabling infinite generation of encoded symbols and/or continuous transmission of a message until the message is decoded), the MIMO spinal code encoding schemes described herein may be better suited for unpredictable and/or varying channel conditions as compared to fixed-rate LDPC and/or polar codes, resulting in fewer communication errors in varying channels and thus less computing, power, and/or network resource consumption than otherwise required for correcting communication errors. Additionally or alternatively, spinal codes may be equipped to handle a variety of channels without requiring specific channel state information (CSI), enabling high performance across multiple channel scenarios, further resulting in fewer communication errors and thus less computing, power, and/or network resource consumption than otherwise required for correcting communication errors.

In some other examples, because spinal codes may be associated with a simpler encoding process as compared to LDPC and/or polar codes, the described techniques can be used to decrease an encoding complexity at a transmitter, thereby reducing power, computing, and/or other resource consumption at the transmitter (for example, a network node or a UE, among other examples). Additionally or alternatively, because spinal codes may require reduced feedback from a receiver as compared to LDPC codes and/or polar codes (for example, due to the rateless nature of spinal codes, among other examples), the described techniques can be used to decrease power, computing, and/or network resource consumption otherwise associated with feedback communications sent from a receiver to a transmitter.

In some other examples, by using a MIMO puncturing scheme that is associated with selectively transmitting spinal symbols associated with fewer than all spines of multiple spines associated with the MIMO spinal code encoding scheme, a message may be transmitted to a receiver using fewer network resources (for example, REs) than are required using LDPC codes and/or polar codes, thereby increasing network bandwidth and/or otherwise improving network efficiency. In some other aspects, by using a MIMO puncturing scheme that is associated with transmitting multiple spinal symbols associated with the at least one spine, redundant symbols may be transmitted to the receiver to improve communications and/or reduce error rates, thus conserving power, computing, and network resources otherwise required for correcting communication errors.

In some examples, the MIMO spinal code encoding schemes described herein may enable improved demodulation and/or decoding procedures as compared to demodulation and/or decoding procedures associated with LDPC codes and/or polar codes, among other examples. For example, the MIMO spinal code encoding schemes described herein may enable joint demodulation-decoding of a message, in the Euclidian domain, and/or may enable utilization of dependencies between the layers (for example, that came from the communication channel) to achieve improved spectral efficiency and/or low decoding complexity.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G NR is part of a continuous mobile broadband evolution promulgated by the 3GPP. 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

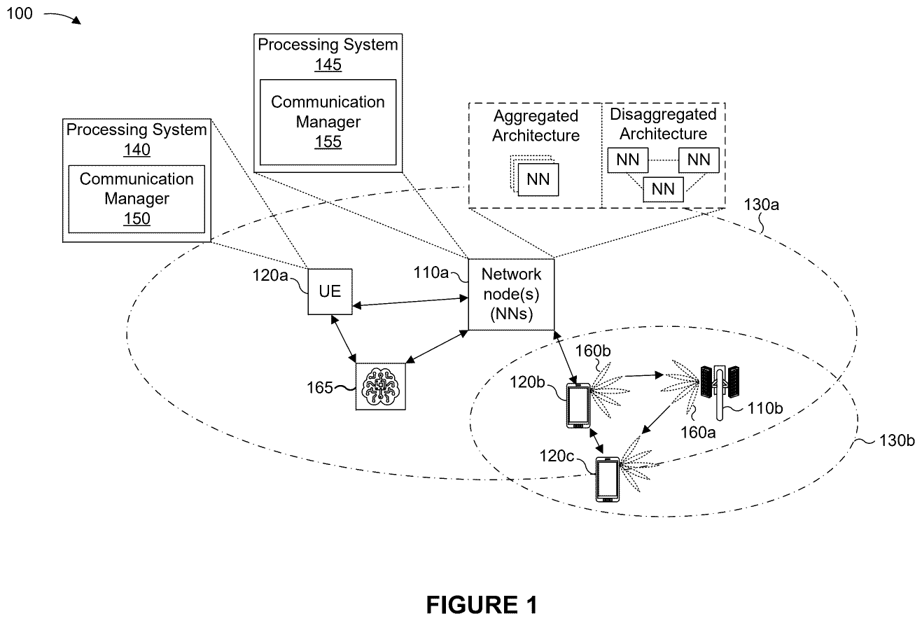

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as the processing system 140 and/or the processing system 145. In some examples, each of the antenna elements of an antenna may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different quantities of antenna elements. For example, a UE 120 may include a single antenna element, two antenna elements, four antenna elements, eight antenna elements, or a different quantity of antenna elements. As another example, a network node 110 may include eight antenna elements, 24 antenna elements, 64 antenna elements, 128 antenna elements, or a different quantity of antenna elements. Generally, a larger quantity of antenna elements may provide increased control over parameters for beam generation relative to a smaller quantity of antenna elements, whereas a smaller quantity of antenna elements may be less complex to implement and may use less power than a larger quantity of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

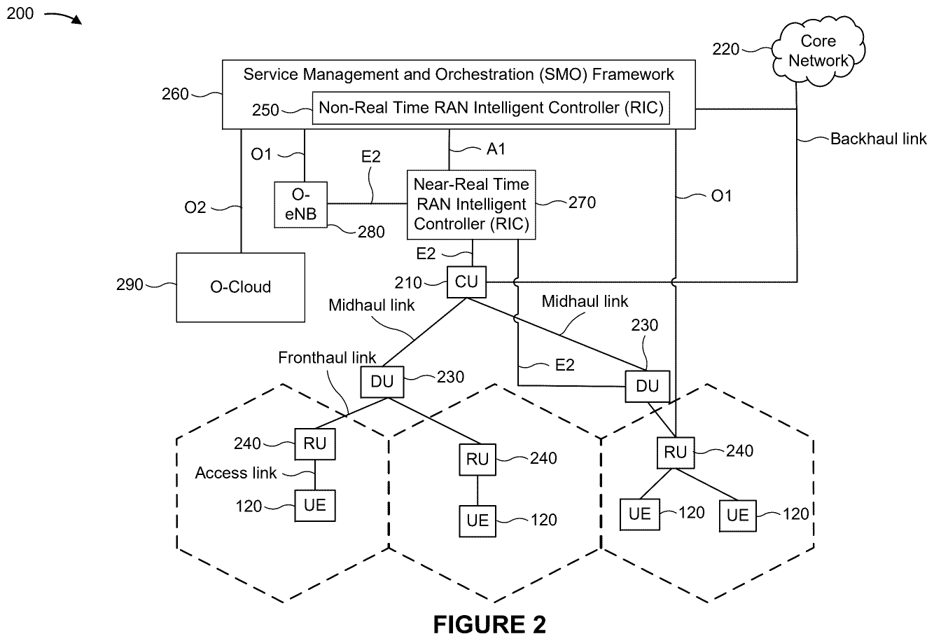

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, in accordance with a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move in accordance with the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified in accordance with different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) in accordance with changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a LDPC code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In the wireless communication network 100, information may be represented as a sequence of binary bits that are mapped (for example, modulated) to an analog signal waveform that is transmitted to a receiver over a wireless communication channel. In some cases, however, the wireless communication channel may introduce errors that corrupt the transmitted signal due to random noise, interference, device impairments, and/or other factors. At the receiver, the received signal (that may have been corrupted during transmission) is mapped back to binary bits, with the received binary information estimating the transmitted binary information. Accordingly, because errors may corrupt the signal that is estimated at the receiver, channel coding or forward error correction (FEC) techniques are often used to control errors in data transmission over unreliable or noisy communication channels or otherwise mitigate the bit errors that may occur due to noise, interference, and/or other factors. For example, channel coding generally includes an encoding operation performed at a transmitter (for example, a first wireless device, which may be a UE 120 or a network node 110) and a decoding operation performed at a receiver (for example, a second wireless device, which may be a UE 120 or a network node 110). Channel coding is generally accomplished by selectively introducing redundancy into the transmitted information stream, typically using an error correction code (ECC), which allows the receiver to detect errors and/or correct bit errors in the received data stream and thereby provide more reliable information transmission. Accordingly, channel codes are often used in scenarios where retransmissions are undesirable and/or high transmission reliability is needed, such as downlink and/or uplink control channel communications.

For example, in some cases, the wireless communication network 100 may use polar codes to implement channel coding for downlink and/or uplink control channel communications. More particularly, polar coding is a linear block coding technique that has provable capacity-achieving performance over binary channels with polynomial complexity in various scenarios (such as channel coding, among others). Polar coding has a built-in channel polarization structure that uses a recursive construction to split (or “polarize”) a communication channel into reliable subchannels that are very good for transmitting information and unreliable subchannels that are very bad for transmitting information. The reliable subchannels may be almost completely noiseless, with a capacity that approaches 1, and the unreliable subchannels may be almost completely noisy, with a capacity that approaches 0. During polar encoding, a polar transform is applied to assign information bits to the reliable subchannels and to assign “frozen” or “fixed” bits (for example, “0” bits) to the unreliable subchannels. For example, a polar code with a rate R=K/N may be defined in accordance with a set of parameters {N, K, G_{N}, A}, where N is a code block length with N=2ⁿ, for n≥1, K is a code dimension, A is a data index set, A⊂{1, 2, . . . , N} with size |A|=K, and G_{N} is a polar transform defined by:

$${G}_{2} = [ \begin{matrix}1 & 0 \\ 1 & 1\end{matrix} ] , {G}_{N} = [ \begin{matrix}{G}_{N / 2} & 0 \\ {G}_{N / 2} & {G}_{N / 2}\end{matrix} ] = {G}_{2}^{⊗ n}$$

Given a data block d=(d₁, . . . , d_{K}), a polar code with the parameters {N, K, G_{N}, A} encodes the data block d in two steps, where the first step is to construct a transform input block u=(u₁, . . . , u_{N}) by setting:

$${u}_{A} {=}^{△} ( {u}_{i} : i ∈ A ) = d , {u}_{{A}^{C}} {=}^{△} ( {u}_{i} : i ∈ {A}^{C} ) = 0$$

and the second step is to compute the code block x by computing the polar transform of u, where x=uG_{N}. Accordingly, polar codes have an encoding/decoding complexity given by N log N, a construction complexity that is roughly 0(N), and a block error probability that approaches zero roughly as 2^{-\sqrt{N}} for any fixed rate R that is less than a channel capacity (for example, there is no error floor).

In some other cases, the wireless communication network 100 may use LDPC codes to implement channel coding for downlink and/or uplink control channel communications. A communication may be encoded based at least in part on an LDPC code to provide for error detection at a receiver. Encoding for an LDPC may be performed based at least in part on a base graph (for example, a sparse bipartite graph) that may identify a code word to be generated from an input data set and/or information to append to an input data set to form the LDPC.

More particularly, a transmitter may be in wireless communication with a receiver. When the transmitter transmits data to the receiver, the transmitter may first encode the data using an error correcting code, such as an LDPC code. The transmitter may process raw data to be transmitted to the receiver by feeding the raw data through an LDPC encoder, among other signal processing components. The transmitter may perform other signal processing operations (for example, interleaving or the like). The LDPC encoder may add error correction bits to the raw data based at least in part on a selected base graph and/or based at least in part on a target code rate, forming a stream of encoded data. In some examples, “code rate” may refer to a quantity of raw data bits divided by a total quantity of bits in an encoded data stream (for example, the code rate is the proportion of the data stream that is useful, or non-redundant), and thus LDPC coding or similar processes associated with a lower code rate provide more error protection, but require additional overhead, than LDPC coding or similar processes associated with a higher code rate. The encoded data may be transmitted by the transmitter to the receiver using a RAN or the like, where the encoded data is fed through an LDPC decoder (and, in some aspects, other signal processing components such as a deinterleaver, or the like) in order to extract the raw data therefrom.

In some aspects, the UE 120 may include a processing system 140 and/or a communication manager 150. As described in more detail elsewhere herein, the communication manager 150 may encode a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme; map the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme; and transmit, using the multiple transmit antennas and the one or more REs, the multiple spinal symbols. In some other aspects, the communication manager 150 may receive, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme; and decode the multiple spinal symbols, resulting in multiple message bits associated with the message. Additionally or alternatively, the communication manager 150 may perform one or more other operations described herein.

In some aspects, the network node 110 may include a processing system 145 and/or a communication manager 155. As described in more detail elsewhere herein, the communication manager 155 may encode a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme; map the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme; and transmit, using the multiple transmit antennas and the one or more REs, the multiple spinal symbols. In some other aspects, the communication manager 155 may receive, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme; and decode the multiple spinal symbols, resulting in multiple message bits associated with the message. Additionally or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

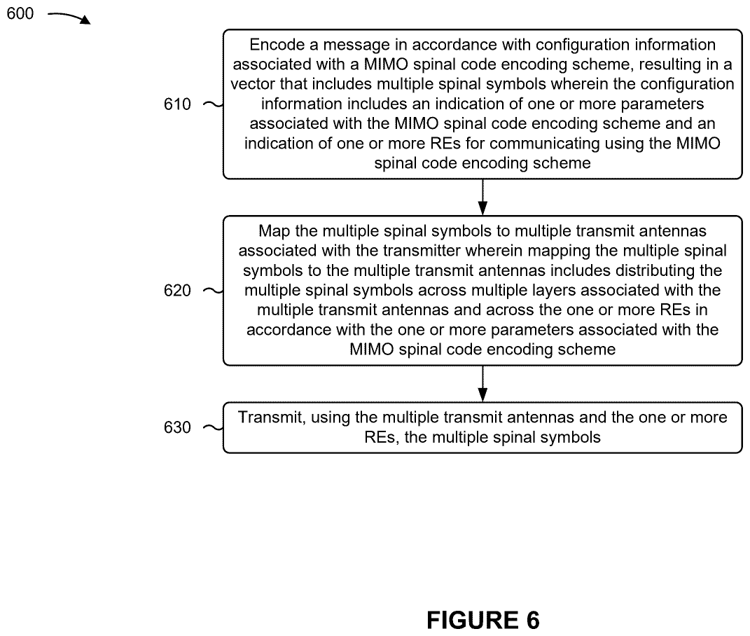

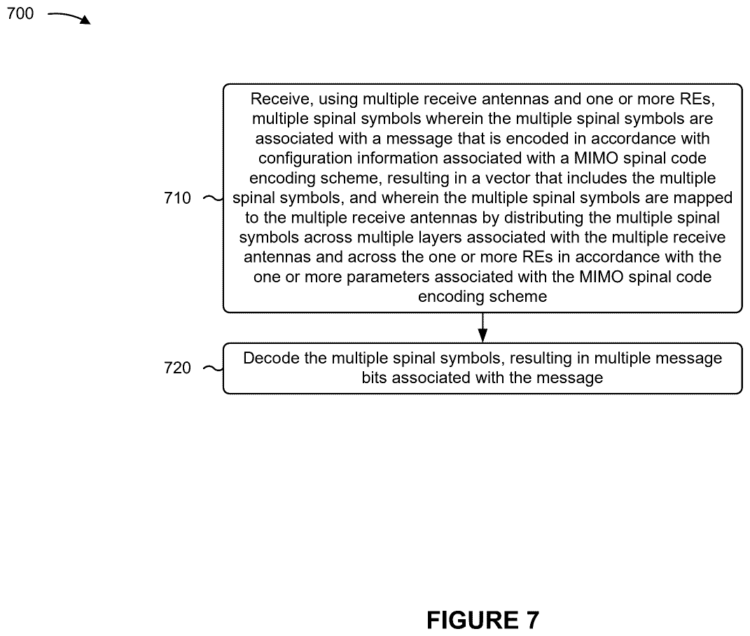

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with spinal coding schemes for MIMO wireless communications, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). In some aspects, the transmitter and/or receiver described herein is the network node 110, is included in the network node 110, or includes one or more components of the network node 110 shown in FIG. 1. Additionally or alternatively, in some aspects, the transmitter and/or receiver described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

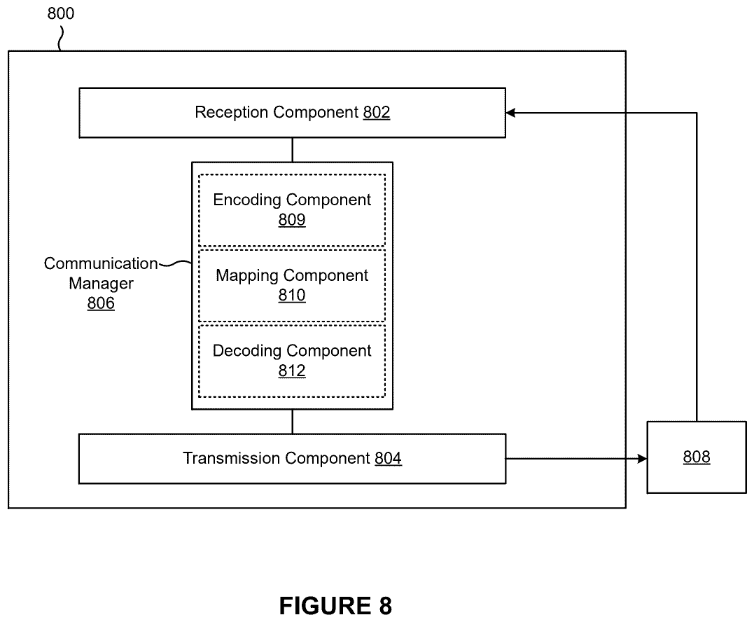

In some aspects, the UE 120 may include means for encoding a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme; means for mapping the multiple spinal symbols to multiple transmit antennas associated with the UE 120, wherein the means for mapping the multiple spinal symbols to the multiple transmit antennas includes means for distributing the multiple spinal symbols across multiple layers associated with the multiple transmit antennas and across the one or more REs in accordance with the one or more parameters associated with the MIMO spinal code encoding scheme; and means for transmitting, using the multiple transmit antennas and the one or more REs, the multiple spinal symbols. In some other aspects, the UE 120 may include means for receiving, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme; and means for decoding the multiple spinal symbols, resulting in multiple message bits associated with the message. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

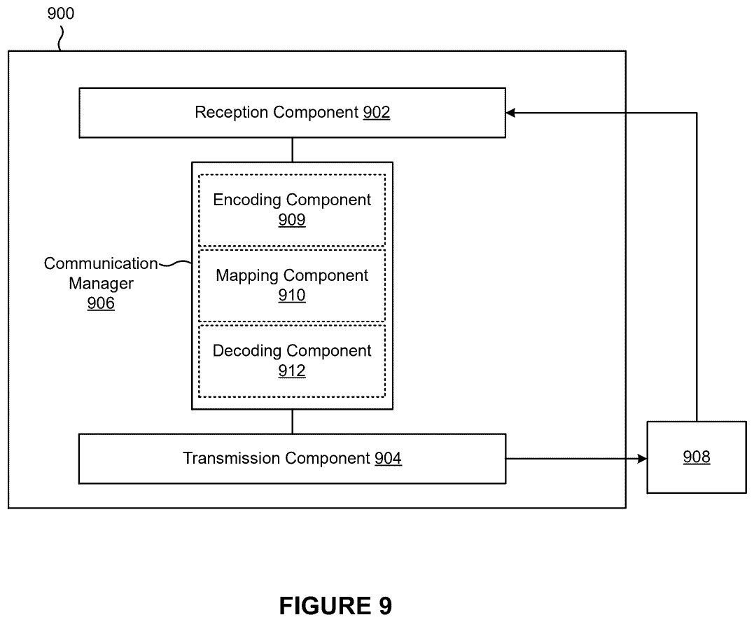

In some aspects, the network node 110 may include means for encoding a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme; means for mapping the multiple spinal symbols to multiple transmit antennas associated with the network node 110, wherein the means for mapping the multiple spinal symbols to the multiple transmit antennas includes means for distributing the multiple spinal symbols across multiple layers associated with the multiple transmit antennas and across the one or more REs in accordance with the one or more parameters associated with the MIMO spinal code encoding scheme; and means for transmitting, using the multiple transmit antennas and the one or more REs, the multiple spinal symbols. In some other aspects, the network node 110 may include means for receiving, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme; and means for decoding the multiple spinal symbols, resulting in multiple message bits associated with the message. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, reception component 904 depicted and described in connection with FIG. 9), among other examples.

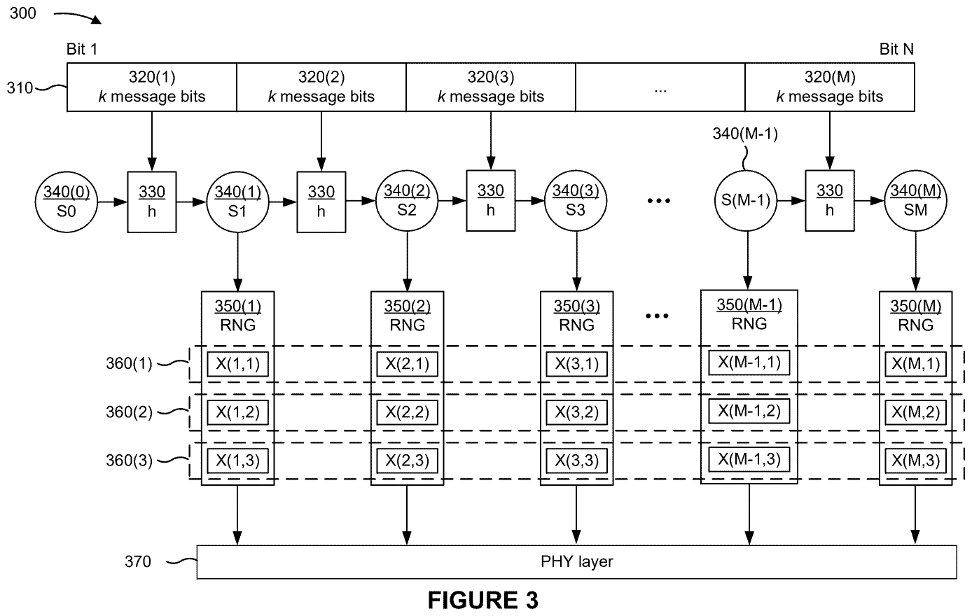

FIG. 3 is a diagram illustrating an example 300 associated with encoding of spinal codes in accordance with the present disclosure. Other transmission schemes may involve different encoding of spinal codes.

As shown, a transmitter may break up an input message 310 into blocks (or groups, chunks, or the like) of message bits 320(1)-320(M). The message may have a total of N bits, and each of the blocks of message bits 320(1)-320(M) may have a total of k bits. Thus, the total quantity of the blocks of message bits 320(1)-320(M) may be N/k (for example, M=N/k). The transmitter may sequentially apply, to the blocks of message bits 320(1)-320(M), a hash function 330 (“h”). The hash function 330 may be designed such that a difference between two input messages in at least one bit results in a different coded sequence after the at least one bit, which may provide resilience to noise and bit errors.

The hash function 330 may also operate on v-bit states 340(0)-340(M-1), where v may be any suitable number (for example, 32). Thus, the hash function 330 may take two inputs: the blocks of message bits 320(1)-320(M) and the v-bit states 340(0)-340(M-1). The hash function 330 may output the v-bit states 340(1)-340(M) based at least in part on the blocks of message bits 320(1)-320(M) and the v-bit states 340(0)-340(M-1). In some examples, h: {0,1}^{v}×{0,1}^{k}→{0,1}^{v}. In some examples, sᵢ=h(sᵢ₋₁, m̅ᵢ), where sᵢ is an i^{th} v-bit state 340(i) and m̅ᵢ is an i^{th} block of message bits 320(i).

For example, initially, the hash function 330 may take, as input, the block of message bits 320(1) and the v-bit state 340(0). The hash function 330 and the v-bit state 340(0) may be known to the transmitter and the receiver. In some examples, the v-bit state 340(0) may be zero. The hash function 330 may output the v-bit state 340(1), take, as input, the block of message bits 320(2) and the v-bit state 340(1), and output the v-bit state 340(2). This process may continue until the hash function 330 outputs the v-bit state 340(M). In this manner, the transmitter may generate a “spine” of v bit states 340(1)-340(M) by sequentially hashing together the blocks of message bits 320(1)-320(M) from the input message 310 without adding redundancy bits.

The hash function 330 may provide the v-bit states 340(1)-340(M) as input (for example, seeds) to random number generators (RNGs) 350(1)-350(M). In some examples, the RNGs 350(1)-350(M) may be known to the transmitter and the receiver. The RNGs 350(1)-350(M) may generate sequences of random c-bit binary numbers: RNG: {0,1}^{v}× [symbol] →{0,1}^{c}. Thus, the transmitter may randomly map the blocks of message bits 320(1)-320(M) to respective c-bit binary numbers. In some examples, a c-bit binary number may be a binary word that includes c bits. In some examples, the c-bit binary numbers may map to output IQ constellation symbols. For example, the transmitter may use a mapping function to randomly select the output IQ constellation symbols. In this manner, the transmitter may produce a sequence of coded bits and symbol for transmission. In some examples, the total quantity of the blocks of message bits 320(1)-320(M) may be equal to the total quantity of transmitted symbols.

In some examples, each of the RNGs 350(1)-350(M) may generate multiple sequences of random c-bit binary numbers. For example, in a first pass 360(1), the RNGs 350(1)-350(M) may generate first sequences of random c-bit binary numbers. The transmitter may, using the mapping function, convert the random c-bit binary numbers into first output IQ constellation symbols. The transmitter may transmit, at a PHY layer 370, one or more samples corresponding to the first output IQ constellation symbols, and if the receiver responds with a NACK, then the RNGs 350(1)-350(M) may, in a second pass 360(2), generate second sequences of random c-bit binary numbers. A sample may occupy a time window (for example, a slot) during which a transmitted signal has a given amplitude and/or phase corresponding to a given symbol (for example, a sample may encode a symbol). The transmitter may, using the mapping function, convert the second sequences of random c-bit binary numbers into second output IQ constellation symbols. The transmitter may transmit, at the PHY layer 370, one or more samples corresponding to the second output IQ constellation symbols, and if the receiver responds with a NACK, then the RNGs 350(1)-350(M) may, in a third pass 360(3), generate third sequences of random c-bit binary numbers. The transmitter may, using the mapping function, convert the third sequences of random c-bit binary numbers into third output IQ constellation symbols. The transmitter may transmit, at the PHY layer 370, one or more samples corresponding to the third output IQ constellation symbols. This process may continue until the transmitter receives an ACK from the receiver or a timeout occurs. As used in FIG. 3, the notation “X(Y,Z)” refers to a Z^{th} pass performed by a Y^{th} RNG. In some examples, the transmitter may transmit one symbol per v-bit state per pass; thus, if the receiver takes l passes to decode the input message 310, then the effective rate is k/l bits per channel use, where k is the maximum rate.

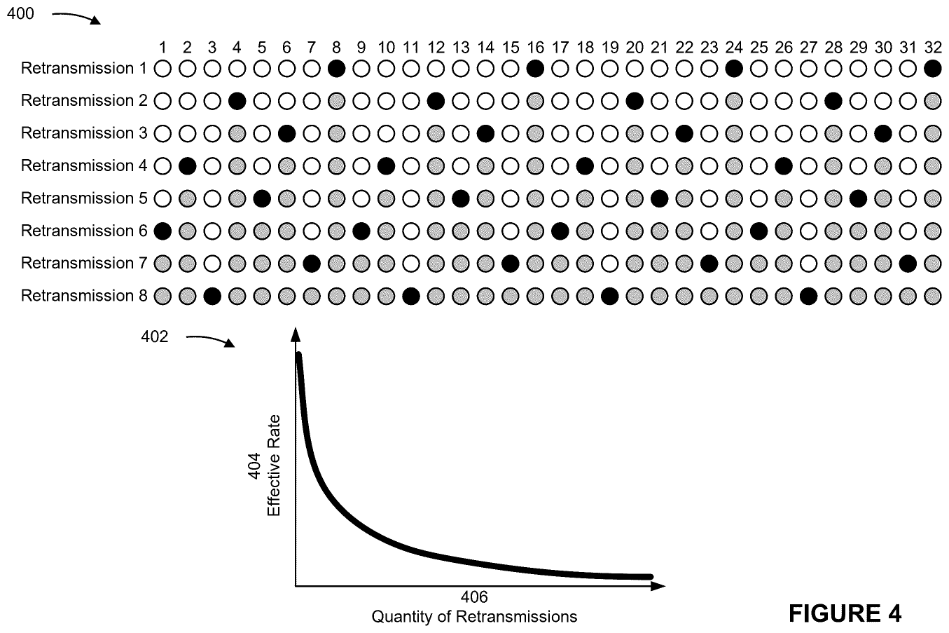

The receiver (for example, decoder) may sequentially process the received samples until the input message 310 is successfully decoded or a timeout occurs. If the timeout occurs, then the transmitter may proceed to a subsequent input message. This may be more readily understood with reference to FIG. 4.

FIG. 4 is a diagram illustrating an example 400 associated with a puncturing scheme for spinal codes in accordance with the present disclosure.

In the example 400, a transmitter may transmit spinal symbols to a receiver using a quantity of retransmissions (sometimes referred to as a quantity of subpasses), indexed in FIG. 4 as retransmission 1 through retransmission 8 (but which may include more or fewer retransmissions in other examples). In each retransmission, the transmitter transmits symbols for spine values marked by black circles, while grey circles indicate symbols that have already been transmitted (for example, in a previous retransmission). In such examples, choosing a quantity of transmitted symbols per retransmission may dictate a rate granularity for the spinal code.

More particularly, in an example in which 256 message bits are to be transmitted (for example, N=256), with each block of message bits (corresponding to each circle in FIG. 4) including eight bits (for example, k=8), the spinal code may be associated with 32 spines (for example, quantity of spines=N/k=32, as described above in connection with FIG. 3). In such an example, a quantity (for example, less than all) of the spinal codes may be transmitted in each retransmission. More particularly, in the first retransmission, the spinal symbols associated with spines indexed 8, 16, 24, and 32 may be transmitted, shown using black circles in connection with the row corresponding to retransmission 1. In the second retransmission, the spinal symbols associated with spines indexed 4, 12, 20, and 28 may be transmitted, shown using black circles in connection with the row corresponding to retransmission 2. Moreover, because the spinal symbols associated with spines indexed 8, 16, 24, and 32 may have previously been transmitted at this point in time (for example, in retransmission 1), those spinal symbols are shown using grey circles in retransmission 2. The transmitter may continue to transmit spinal symbols in this manner until the message is successfully decoded by the receiver or until all spinal symbols have been transmitted (for example, as shown in connection with retransmission 8).

In this regard, the receiver may attempt to decode the message after each retransmission. In some examples, a receiver may decode the received spinal symbols using a bubble decoder and/or a bubble decoding algorithm. The bubble decoding algorithm for spinal codes involves navigating a tree of potential messages using a pruned breadth-first search approach. In this regard, each node in the tree represents a potential message, with edges corresponding to chunks of k information bits. To manage computational complexity, only a fixed quantity of B nodes are retained at each level, forming a group known as the “beam.” The decoder works with received symbols and candidate messages, scoring them based on the minimum square error (MSE) cost of the candidate message. If the quantity of nodes exceeds the prescribed maximum B, the decoder proceeds to the next spine only with those B nodes possessing lower costs. The upper bound for the count of MSE calculations in a bubble decoding process is roughy

$$\frac{n}{k} \cdot B ,$$

with the omission of calculations performed at the tree's initial stages.

Once the message is successfully decoded, the receiver may transmit an acknowledgement message to the transmitter, and the transmitter may forgo transmitting any remaining retransmissions. In that regard, in some examples the spinal code may be considered “rateless,” because a coding rate of the spinal code may not be set and/or may vary based on channel conditions, among other examples. For example, as shown in the plot 402, which includes an effective coding rate axis 404 and a quantity of retransmissions axis 406, an effective coding rate may decrease as a quantity of retransmissions used to transmit a message increases. For example, returning to the example described above, the spinal code may start a rate of 8 bits per channel use and may decrease in a manner consistent with the plot 402 as more retransmissions are used, with the total quantity of transmitted symbols per retransmission (for example, four in the above-described example 400) dictating the effective rate granularity. In some examples, using a spinal code as a rateless code may enable use of the spinal code even in the absence of utilizing CSI-RSs or similar mechanisms for determining optimal transmission schemes (for example, optimal MCSs, among other examples). In some other examples, a spinal code may be associated with a fixed rate (for example, the rate of the spinal code may be determined and/or fixed when encoding data), in a similar manner to LDPC codes and/or polar codes, among other examples. For example, a spinal code encoder may limit a quantity of spinal symbols generated and/or a transmitter may transmit a fixed quantity of spinal symbols in a channel, thereby setting a fixed rate for the spinal code. Additionally, or alternatively, spinal codes may be used in a similar manner as LDPC codes and/or polar codes, however, an MCS may be used to generate an equivalent puncturing scheme for the spinal code, among other examples.

In some examples, using spinal codes in MIMO-based wireless communication systems may reduce losses and thus reduce communication errors, resulting in more efficient communications. For example, in a 2×2 MIMO scheme using random precoding (for example, a MIMO scheme using two transmit antennas mapped to two layers and two receive antennas mapped to the two layers), polar codes and/or LDPC (for example, using a bit-interleaved coded modulation (BICM) scheme) codes may result in an approximate 5 decibel (dB) gap from a Shannon limit (a theoretical maximum rate at which information can be transmitted over a communication channel with a given bandwidth and noise level, while still being able to recover the original information with negligible errors), which may include approximately 1.5 dB of shaping loss and approximately 1 dB of coding loss, as well as additional small losses such as demodulator losses, alphabet losses, and/or log-likelihood ratio (LLR) calculation losses, among other examples. In such an example, a potential gain of approximately 3.5 dB may be achieved using a better coded modulation scheme (for example, by using spinal codes rather than LDPC and/or polar codes). Similarly, for other MIMO scenarios the gain may be more significant. For example, for a 4×4 MIMO scenario using random precoding (for example, a MIMO scheme using four transmit antennas mapped to four layers and four receive antennas mapped to the four layers), a potential gain of approximately 4.5 dB may be achieved using a better coded modulation scheme (for example, by using spinal codes rather than LDPC and/or polar codes). In this regard, the potential gain (for example, the reduced gap from a Shannon limit) may increase with an increase in a quantity of layers.

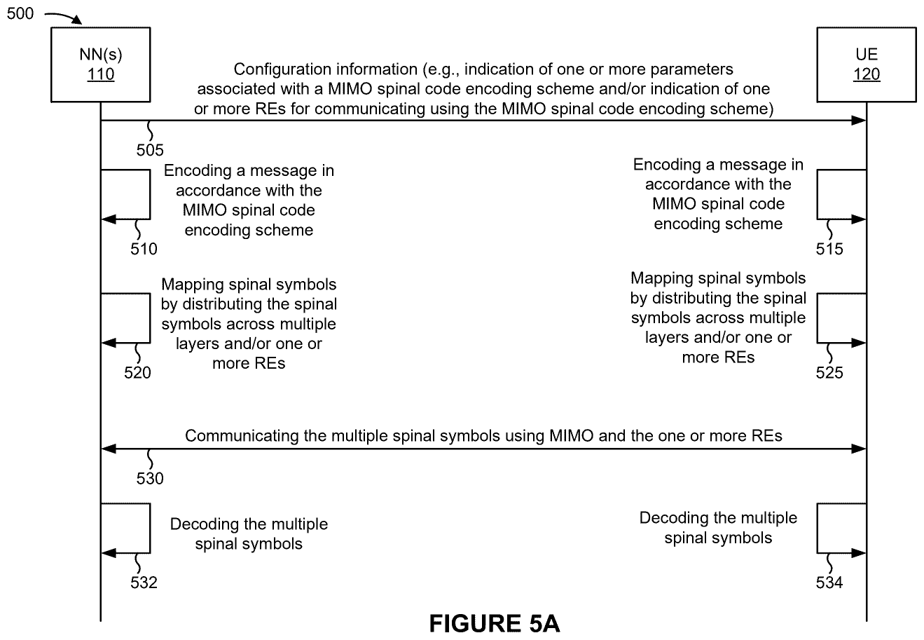

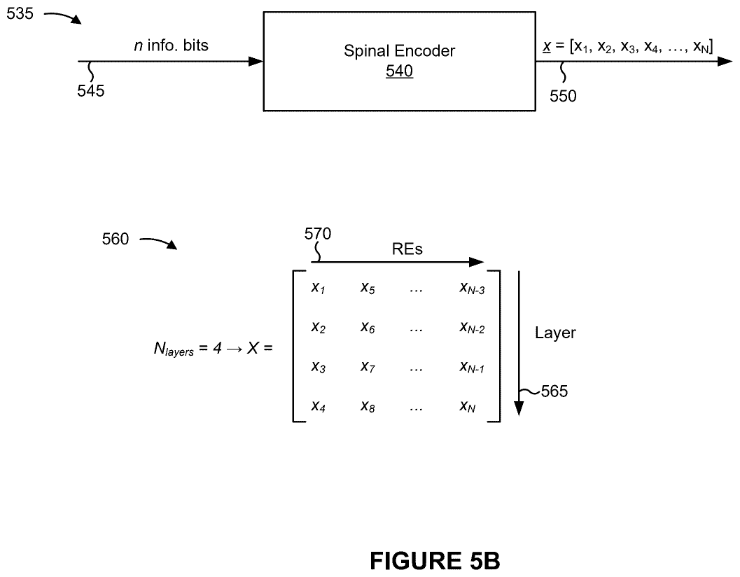

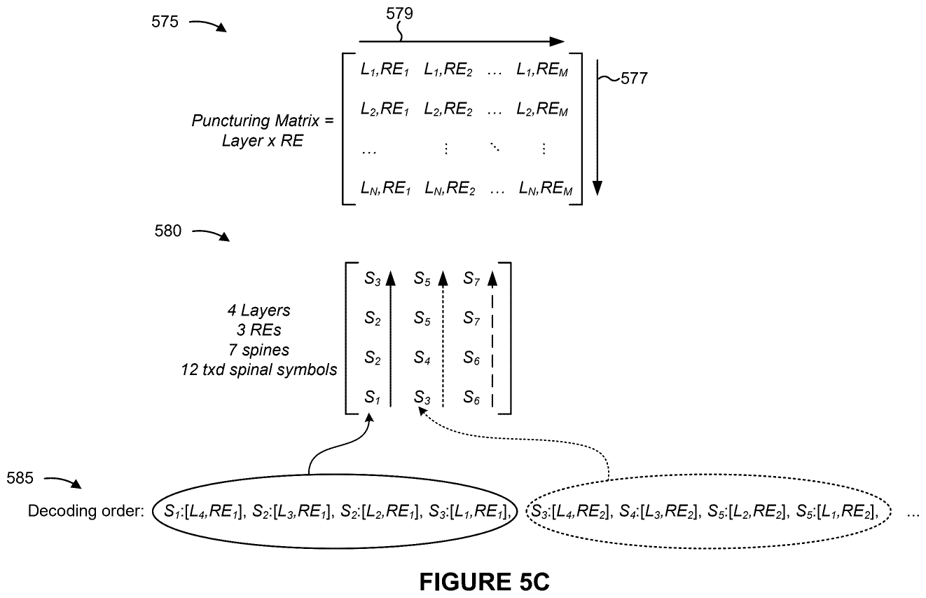

FIGS. 5A-5C are diagrams of examples associated with spinal coding schemes for MIMO wireless communications in accordance with the present disclosure. As shown in FIG. 5A, in example 500, a network node 110 (for example, a CU, a DU, and/or an RU) may communicate with a UE 120. In some aspects, the network node 110 and the UE 120 may be part of a wireless network (for example, wireless communication network 100). The UE 120 and the network node 110 may have established a wireless connection prior to operations shown in FIG. 5A.

In some aspects, the network node 110 and/or the UE 120 may be capable of communicating using spinal codes. In such aspects, one of the network node 110 or the UE 120 may correspond to a transmitter when the one of the network node 110 or the UE 120 is encoding messages using spinal codes and transmitting the messages to the other of the network node 110 or the UE 120, and thus the other of the network node 110 or the UE 120 may correspond to a receiver. In some aspects, the network node 110 and/or the UE 120 may correspond to both a transmitter and a receiver. For example, the network node 110 may be a transmitter, and thus the UE 120 may be a receiver, for a first message (for example, the network node 110 may encode the first message using a spinal code and/or may transmit the encoded first message to the UE 120), the UE 120 may be a transmitter, and thus the network node 110 may be a receiver, for a second message (for example, the UE 120 may encode the second message using a spinal code and/or may transmit the encoded second message to the network node 110), and so forth.

In a first operation 505, the network node 110 may transmit, and the UE 120 may receive, configuration information. In some aspects, the UE 120 may receive the configuration information via one or more of system information (for example, a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC CEs and/or one or more DCI messages, among other examples.

In some aspects, the configuration information may include an indication of one or more parameters associated with a MIMO spinal code encoding scheme and an indication of one or more REs for communicating using the MIMO spinal code encoding scheme. In such aspects, the one or more parameters may indicate a quantity of spines (for example, a quantity of a v bit states, as described above in connection with FIG. 3) associated with the MIMO spinal code encoding scheme, a quantity of the multiple spinal symbols to be encoded using the MIMO spinal code encoding scheme, a quantity of multiple transmit antennas to be used to transmit multiple spinal symbols (for example, symbols encoded using the MIMO spinal code encoding scheme), a quantity of multiple receive antennas to be used to receive the multiple spinal symbols, a quantity of the multiple layers associated with the MIMO spinal code encoding scheme, a quantity of one or more REs to be used to communicate the encoded message, or an indication of a MIMO puncturing scheme associated with the MIMO spinal code encoding scheme, among other examples.

In aspects in which the configuration information indicates a MIMO puncturing scheme associated with the MIMO spinal code encoding scheme, the MIMO puncturing scheme may be associated with selectively transmitting spinal symbols associated with fewer than all spines of the multiple spines. Put another way, the MIMO puncturing scheme may indicate from which spines, of the multiple spines, spinal symbols are to be transmitted and/or how to map transmitted spinal symbols to the multiple layers and the one or more REs. In such aspects, the configuration information may indicate which spinal symbols are to be transmitted and/or a total quantity of spinal symbols to be transmitted, among other information. Additionally or alternatively, the MIMO puncturing scheme may be associated with, for at least one spine of the multiple spines, transmitting multiple spinal symbols associated with the at least one spine (for example, the MIMO puncturing scheme may be associated with transmitting redundant spinal symbols). In such aspects, the configuration information may indicate which spinal symbols are to be transmitted multiple times and/or a quantity of redundant symbols to be transmitted, among other information. Additionally or alternatively, the MIMO puncturing scheme may be associated with transmitting a first quantity of spinal symbols for a first spine and transmitting a second quantity of spinal symbols for a second spine, with the first quantity differing from the second quantity. In such aspects, the configuration information may indicate the first and second quantities, among other information. Aspects of example MIMO puncturing schemes are described below in more detail in connection with FIG. 5C.

The UE 120 may configure itself based at least in part on the configuration information. In some aspects, the UE 120 may be configured to perform one or more operations described herein based at least in part on the configuration information.

In some aspects, the UE 120 may transmit, and the network node 110 may receive, capability information (for example, a capabilities report) (not shown). The capability information may indicate whether the UE 120 supports a feature and/or one or more parameters related to the feature. For example, the capability information may indicate a capability and/or parameter for communicating using spinal codes. As another example, the capability information may indicate a capability and/or parameter for communicating using a MIMO spinal code encoding scheme, such as the MIMO spinal code encoding scheme described herein (for example, a spinal code encoding scheme in which spinal codes are mapped to multiple layers and/or multiple REs). One or more operations described herein may be based on the capability information. For example, the UE 120 may perform a communication in accordance with the capability information, or may receive configuration information (for example, the configuration information described above in connection with the first operation 505) that is in accordance with the capability information.

In some aspects, the configuration information described in connection with the first operation 505 and/or the capability information may include information transmitted via multiple communications. Additionally or alternatively, the network node 110 may transmit the configuration information, or a communication including at least a portion of the configuration information, before and/or after the UE 120 transmits the capability information. For example, the network node 110 may transmit a first portion of the configuration information before the capability information, the UE 120 may transmit at least a portion of the capability information, and the network node 110 may transmit a second portion of the configuration information after receiving the capability information.

In a second operation 510 or a third operation 515, the network node 110 or the UE 120, respectively, may encode a message in accordance with the configuration information, resulting in a vector that includes multiple spinal symbols. More particularly, in aspects in which the network node 110 is the transmitter and the UE 120 is the receiver, at the second operation 510 the network node 110 may encode a message in accordance with the configuration information, resulting in a vector that includes multiple spinal symbols. Additionally or alternatively, in aspects in which the UE 120 is the transmitter and the network node 110 is the receiver, at the third operation 515 the UE 120 may encode a message in accordance with the configuration information, resulting in a vector that includes multiple spinal symbols. Aspects of encoding a message using a MIMO spinal code encoding scheme, resulting in a vector that includes multiple spinal symbols, are described in more detail below in connection with FIG. 5B and example 535.

In a fourth operation 520 or a fifth operation 525, the network node 110 or the UE 120, respectively, may map the multiple spinal symbols to multiple transmit antennas, such as by distributing the multiple spinal symbols across multiple layers associated with the multiple transmit antennas and across the one or more REs in accordance with the one or more parameters associated with the MIMO spinal code encoding scheme. More particularly, in aspects in which the network node 110 is the transmitter and the UE 120 is the receiver, at the fourth operation 520 the network node 110 may map the multiple spinal symbols to multiple transmit antennas associated with the network node 110, such as by distributing the multiple spinal symbols across multiple layers associated with the multiple transmit antennas and across the one or more REs in accordance with the one or more parameters associated with the MIMO spinal code encoding scheme. Additionally or alternatively, in aspects in which the UE 120 is the transmitter and the network node 110 is the receiver, at the fifth operation 525 the UE 120 may map the multiple spinal symbols to multiple transmit antennas associated with the UE 120, such as by distributing the multiple spinal symbols across multiple layers associated with the multiple transmit antennas and across the one or more REs in accordance with the one or more parameters associated with the MIMO spinal code encoding scheme. In some aspects, mapping the multiple spinal symbols to the multiple transmit antennas in accordance with the transmit matrix may include mapping the multiple layers to the multiple transmit antennas according to a precoding matrix (for example, according to a precoding matrix that converts layers to physical antennas). More particularly, as described above in connection with the second operation 510 and the third operation 515, the network node 110 or the UE 120, respectively, may encode the message, resulting in the vector that includes multiple spinal symbols. Accordingly, in the fourth operation 520 or the fifth operation 525, the network node 110 or the UE 120, respectively, may map, using the precoding matrix (for example, a precoding matrix associated with random precoding, among examples) the vector into the transmit matrix. Aspects of mapping multiple spinal symbols to multiple layers and/or one or more REs are described in more detail below in connection with FIG. 5B and example 560.

In a sixth operation 530, the network node 110 and the UE 120 may communicate the multiple spinal symbols using MIMO and the one or more REs (for example, the one or more REs indicated via the configuration information). More particularly, in aspects in which the network node 110 is the transmitter and the UE 120 is the receiver, the network node 110 may transmit (for example, using multiple transmit antennas, one for each layer of the MIMO spinal code encoding scheme, and the one or more REs), and the UE 120 may receive (for example, using multiple receive antennas, one for each layer of the MIMO spinal code encoding scheme, and the one or more REs), the multiple spinal symbols. Additionally or alternatively, in aspects in which the UE 120 is the transmitter and the network node 110 is the receiver, the UE 120 may transmit (for example, using multiple transmit antennas, one for each layer of the MIMO spinal code encoding scheme, and the one or more REs), and the network node 110 may receive (for example, using multiple receive antennas, one for each layer of the MIMO spinal code encoding scheme, and the one or more REs), the multiple spinal symbols.

In a seventh operation 532 or an eighth operation 534, the network node 110 or the UE 120, respectively, may decode the multiple spinal symbols, resulting in multiple message bits associated with the message. More particularly, in aspects in which the network node 110 is the receiver and the UE 120 is the transmitter, at the seventh operation 532 the network node 110 may decode the multiple spinal symbols, resulting in multiple message bits associated with the message. Additionally or alternatively, in aspects in which the UE 120 is the receiver and the network node 110 is the transmitter, at the eighth operation 534 the UE 120 may decode the multiple spinal symbols, resulting in multiple message bits associated with the message.

In some aspects, decoding the multiple spinal symbols may include decoding the multiple spinal symbols using a multi-dimensional demodulator across the one or more REs. For example, the network node 110 (for example, in the seventh operation 532) or the UE 120 (for example, in the eighth operation 534) may decode the multiple spinal symbols by, for each RE, decoding a first spinal symbol associated with a first receive antenna, resulting in a first set of decoded message bits, and decoding a second spinal symbol associated with a second receive antenna using the first set of decoded message bits, resulting in a second set of decode message bits. In this way, the MIMO spinal code encoding schemes described herein may enable improved demodulation and/or decoding procedures as compared to demodulation and/or decoding procedures associated with LDPC codes and/or polar codes, among other examples. For example, the MIMO spinal code encoding schemes described herein may enable joint demodulation-decoding of a message, in the Euclidian domain, and/or may enable utilization of dependencies between the layers (for example, that came from the communication channel) to achieve improved spectral efficiency and/or low complexity. Aspects of decoding the multiple spinal symbols are described in more detail below in connection with FIG. 5C (for example, example 585 of FIG. 5C).

FIG. 5B shows an example 535 associated with using a spinal encoder 540 to encode a message into a vector of spinal symbols (such as the vector of spinal symbols described above in connection with the second operation 510 and the third operation 515). The spinal encoder 540 may be located at a transmitter (for example, one of the network node 110 or the UE 120) that is capable of encoding and transmitting messages using a MIMO spinal code encoding scheme and/or that is configured to encode and transmit messages using the MIMO spinal code encoding scheme. In a similar manner as described above in connection with the second operation 510 and the third operation 515 of FIG. 5A, the spinal encoder 540 may be capable of encoding a message using a spinal code (for example, in accordance with the configuration information described above in connection with the first operation 505), resulting in a vector that includes multiple spinal symbols. For example, in aspects in which the transmitter is to transmit N spinal symbols, n information bits 545 may be encoded to N spinal symbols. More particularly, the n information bits 545 may be encoded, using the spinal encoder, to a transmit vector 550 (denoted as x in FIG. 5B) that includes N spinal symbols (for example, x=[x₁, x₂, x₃, x₄, . . . , x_{N}], with xᵢ corresponding to a transmitted spinal symbol). In a similar manner as described above in connection with the fourth operation 520 and the fifth operation 525, the transmit vector 550 may then be mapped to multiple layers and/or one or more REs associated with the MIMO spinal code encoding scheme.

For example, in some aspects, the transmit vector 550 may be mapped to multiple layers and/or one or more REs in accordance with a transmit matrix 560 (sometimes referred to as X) and/or a precoding matrix. The transmit matrix 560 may have a size in a first dimension 565 corresponding to a quantity of layers of the MIMO spinal code encoding scheme (for example, a quantity of transmit antennas and/or receive antennas) and a size in a second dimension 570 corresponding to a quantity of the one or more REs. In such aspects, for each RE in the transmit matrix 560, a subset of the multiple spinal symbols are sequentially ordered in the transmit matrix 560 in accordance with respective spine indexes associated with the subset of the multiple spinal symbols, with the subset of the multiple spinal symbols including a quantity of symbols that corresponds to the quantity of layers.

Put another way, mapping the transmit vector 550 (for example, x) to a quantity of transmit antennas (sometimes referred to herein as N_{TX}) and/or a quantity of REs (sometimes referred to herein as N_{RE}) may include splitting the transmit vector 550 into chunks corresponding to the quantity of layers (sometimes referred to as N_{layers}) and/or generating the transmit matrix 560 (for example, X), where

$$X ∈ {C}^{{N}_{T X} \times {N}_{R E}} , {N}_{R E} = \frac{N}{{N}_{l a y e τ s}} , and {N}_{T X} = {N}_{l a y e r s}$$

(assuming identity (for example, random) precoding). In that regard, in an example involving 4 layers (for example, N_{layers}=4, such as in aspects involving 4×4 MIMO), a first column of the transmit matrix 560 (corresponding to a first configured RE) may include the first four spinal symbols of the transmit vector 550 (for example, x₁, x₂, x₃, and x₄), a second column of the transmit matrix 560 (corresponding to a second configured RE) may include the next four spinal symbols of the transmit vector 550 (for example, x₅, x₆, x₇, and x₈), and so forth through a last column of the transmit matrix 560 (corresponding to a last configured RE) that may include the last four spinal symbols of the transmit vector 550 (for example, x_{N-3}, x_{N-2}, x_{N-1}, and x_{N}). The transmit matrix 560 (for example, X) may then be transmitted from the transmitter (for example, one of the network node 110 or the UE 120) through a matrix channel (sometimes referred to as H, where H∈C^{N}^{_{RE}}^{xN}^{_{RX}}^{xN}^{_{TX}}) to the receiver (for example, the other one of the network node 110 or the UE 120). Accordingly, the received matrix at the receiver (sometimes referred to as Y, where Y∈C^{N}^{_{RE}}^{xN}^{_{RX}}) may be Y=HX+N (with “N” in this expression corresponding to noise in the channel). The received matrix (for example, Y) may then be decoded at the receiver to retrieve the message bits (for example, the n information bits 545), which is described in more detail below in connection with example 585 of FIG. 5C.

As described above in connection with FIG. 5A, in some aspects the transmitter may map the spinal symbols to the transmit antennas (for example, layers) and/or REs in accordance with a MIMO puncturing scheme. FIG. 5C shows an example of a puncturing matrix 575 that may be used to map the spinal symbols to the transmit antennas (for example, layers) and/or REs in accordance with a MIMO puncturing scheme. As shown in FIG. 5C, the order of the puncturing matrix 575 may correspond to the quantity of layers in a first dimension 577 by a quantity of REs in a second dimension 579. For example, in aspects in which the puncturing matrix 575 is associated with N layers and M REs, a first column of the puncturing matrix 575 may include a symbol associated with a first of the N layers and a first of the M REs (shown using the notation L₁,RE₁) through a symbol associated with an N^{th} of the N layers and the first of the M REs (shown using the notation L_{N},RE₁). Similarly, a second column of the puncturing matrix 575 may include a symbol associated with the first of the N layers and a second of the M REs (shown using the notation L₁,RE₂) through a symbol associated with the N^{th} of the N layers and the second of the M REs (shown using the notation L_{N},RE₂). This pattern may generally repeat through a last column (for example, an M^{th} column) of the puncturing matrix 575, which may include a symbol associated with the first of the N layers and an M^{th} of the M REs (shown using the notation L₁,RE_{M}) through a symbol associated with the N^{th} of the N layers and the M^{th} of the M REs (shown using the notation L_{N},RE_{M}).

In some aspects, encoded spinal symbols may be mapped to the puncturing matrix 575 in accordance with a MIMO puncturing scheme (which, in some aspects, may be configured in accordance with the configuration information described in connection with the first operation 505). For example, puncturing matrix 580 shows one example of mapping spinal symbols (denoted as Sᵢ in FIG. 5C, where i corresponds to a spine index, such as an index associated with one of the v bit states described above in connection with FIG. 3) to four layers and three REs. In this example, the message may be encoded using seven spines (for example, the spinal code may be associated with a total of seven v bit states) and/or the encoded message may be transmitted using twelve transmitted spinal symbols (for example, x=x₁, x₂, . . . , x₁₂ in this example). In such examples, because the quantity of transmitted spinal symbols (for example, twelve) exceeds the quantity of spines (for example, seven), the transmitter may transmit the spinal symbols in accordance with a MIMO puncturing scheme in which at least some spinal symbols are transmitted multiple times, such as for a purpose of transmitting redundant symbols and/or improving a decoding process at the receiver.

More particularly, in this aspect a symbol associated with the first spine (for example, S₁) may be transmitted once, using a fourth layer and a first RE (for example, using position L₄,RE₁ of the puncturing matrix 580). Moreover, a symbol associated with the second spine (for example, S₂) may be transmitted twice, using a third layer and a first RE (for example, using position L₃,RE₁ of the puncturing matrix 580) as well as a second layer and a first RE (for example, using position L₂,RE₁ of the puncturing matrix 580). Additionally, a symbol associated with the third spine (for example, S₃) may be transmitted twice, using a first layer and a first RE (for example, using position L₁,RE₁ of the puncturing matrix 580) as well as a fourth layer and a second RE (for example, using position L₄,RE₂ of the puncturing matrix 580). Moreover, a symbol associated with the fourth spine (for example, S₄) may be transmitted once, using a third layer and a second RE (for example, using position L₃,RE₂ of the puncturing matrix 580). Additionally, a symbol associated with the fifth spine (for example, S₅) may be transmitted twice, using a second layer and a second RE (for example, using position L₂,RE₂ of the puncturing matrix 580) as well as a first layer and a second RE (for example, using position L₁,RE₂ of the puncturing matrix 580). Moreover, a symbol associated with the sixth spine (for example, S₆) may be transmitted twice, using a fourth layer and a third RE (for example, using position L₄,RE₃ of the puncturing matrix 580) as well as a third layer and a third RE (for example, using position L₃,RE₃ of the puncturing matrix 580). And a symbol associated with the seventh spine (for example, S₇) may be transmitted twice, using a second layer and a third RE (for example, using position L₂,RE₃ of the puncturing matrix 580) as well as a first layer and a third RE (for example, using position L₁,RE₃ of the puncturing matrix 580).

In some aspects, a decoding process at a receiver may be performed spine by spine, with respect to the order of the spines in the puncturing matrix 580. For example, decoding order 585 depicts how a receiver may decode spinal symbols transmitted in accordance with the puncturing matrix 580. More particularly, as indicated by the solid arrow shown in connection with the column of the puncturing matrix 580 corresponding to the first RE, after receiving the transmitted spinal symbols in the first RE (for example, using multiple receive antennas), the receiver may first decode the symbol associated with the first spine (for example, S₁), followed by the two symbols associated with the second spine (for example, S₂), and then followed by the symbol associated with the third spine (for example, S₃). Similarly, as indicated by the dotted-line arrow shown in connection with the column of the puncturing matrix 580 corresponding to the second RE, after receiving the transmitted spinal symbols in the second RE, the receiver may first decode the symbol associated with the third spine (for example, S₃), followed by the symbol associated with the fourth spine (for example, S₄), and then followed by the two symbols associated with the fifth spine (for example, S₅). Moreover, as indicated by the dashed-line arrow shown in connection with the column of the puncturing matrix 580 corresponding to the third RE, after receiving the transmitted spinal symbols in the third RE, the receiver may first decode the two symbols associated with the sixth spine (for example, S₆), followed by the two symbols associated with the seventh spine (for example, S₇).

In some examples, the receiver may decode the received symbols (for example, the noisy symbols), such as by finding a valid sequence of encoded symbols that matches the received symbols within a certain threshold of noise tolerance. In this regard, a hypothesis of each decoded symbol may be used in decoding subsequent spinal symbols. Put another way, in some aspects, decoding the multiple spinal symbols includes, for each RE, decoding a first spinal symbol, of the multiple spinal symbols, associated with a first receive antenna, of the multiple receive antennas, resulting in a first set of decoded message bits, and decoding a second spinal symbol, of the multiple spinal symbols, associated with a second receive antenna, of the multiple receive antennas, resulting in a second set of decoded message bits, where decoding the second spinal symbol includes decoding the second spinal symbols using the first set of decoded message bits. For example, returning to the example puncturing matrix 580, the receiver may first attempt to decode a symbol associated with the first spine (for example, S₁) and then may use the decoded message bits in attempting to decode a symbol associated with the second spine (for example, S₂), and so forth.

For example, as described above in connection with FIG. 5B, the transmit matrix (for example, X) may be transmitted from the transmitter (for example, one of the network node 110 or the UE 120) through a matrix channel (for example, H, where H∈C^{N}^{_{RE}}^{xN}^{_{RX}}^{xN}^{_{TX}}) to the receiver (for example, the other one of the network node 110 or the UE 120) such that the received matrix at the receiver (for example, Y, where Y∈C^{N}^{_{RE}}^{xN}^{_{RX}}) may be Y=HX+N. In such aspects, the receiver (for example, a spinal decoder component of the receiver) may first whiten the received signal (for example, Y∈C^{N}^{_{RE}}^{xN}^{_{RX}}) and the channel matrix (for example, H∈C^{N}^{_{RE}}^{xN}^{_{RX}}^{xN}^{_{TX}}) to get noise with a variance of one.

This may be achieved by first performing a Cholesky decomposition to a covariance matrix of the noise (sometimes referred to as Rₙₙ), resulting in a noise whitening matrix Wₙₙ, where

$${W}_{n n} = {R}_{nn}^{- \frac{1}{2}} ∈ {C}^{{N}_{R E} \times {N}_{R X} \times {N}_{R X}} .$$

Next, the received signal (for example, Y) and the channel matrix (for example, H) may be multiplied (for example, per RE) by Wₙₙ to get the whitened received signal, Y_{w}, as well as the whitened channel, H_{w}, where Y_{w}=WₙₙY∈C^{N}^{_{RE}}^{xN}^{_{RX}} and where H_{w}=WₙₙH∈C^{N}^{_{RE}}^{xN}^{_{RX}}^{xN}^{_{TX}}. In some aspects, QR decomposition may be made to whitened channel, H_{w}=Q_{w}R_{w}→Y_{w}=Q_{w}R_{w}X+N, where Q is a unitary matrix

$$( {Q}_{w}^{H} {Q}_{w} = I )$$

and R is an upper diagonal matrix. For example, in aspects in which R is associated with a 4×4 matrix, R may be equal to the following:

$$R = ( \begin{matrix}{r}_{11} & {r}_{12} & {r}_{13} & {r}_{14} \\ 0 & {r}_{22} & {r}_{23} & {r}_{24} \\ 0 & 0 & {r}_{33} & {r}_{34} \\ 0 & 0 & 0 & {r}_{44}\end{matrix} )$$

In such aspects, multiplying both sides of the equation Y_{w}=Q_{w}R_{w}X+N by [symbol] results in the expression

$${Q}_{w}^{H} {Y}_{w} = {Q}_{w}^{H} {Q}_{w} R X + {Q}_{w}^{H} N \to {\tilde{Y}}_{w} = {R}_{w} X + \overline{N} ,$$

which corresponds to the following expression:

$$[ \begin{matrix}{Y}_{2 , 1} \\ {Y}_{w , 2} \\ {Y}_{w , 3} \\ {Y}_{w , 4}\end{matrix} ] = [ \begin{matrix}{r}_{11} {x}_{1} + {r}_{12} {x}_{2} + {r}_{13} {x}_{3} + {r}_{14} {x}_{4} \\ {r}_{22} {x}_{2} + {r}_{23} {x}_{3} + {r}_{24} {x}_{4} \\ {r}_{33} {x}_{3} + {r}_{34} {x}_{4} \\ {r}_{44} {x}_{4}\end{matrix} ] + [ \begin{matrix}{N}_{w , 1} \\ {N}_{w , 2} \\ {N}_{w , 3} \\ {N}_{w , 4}\end{matrix} ]$$

The above system of equations may then be iteratively solved by the receiver (for example, the spinal code decoder) for the unknown spinal symbols (for example, xᵢ), such as solving the bottom-most equation Y_{w,4}=r_{44X4}+N_{w,4} for the unknown x₄, using the decoded result (for example, x₄) in the next equation (for example, Y_{w,3}=r₃₃ₓ₃+r₃₄ₓ₄+N_{w,3}) to solve for the unknown x₃, and so forth. In this way, a decoding process may be performed spine by spine, with respect to the order of the spines, as described above in connection with example 585 and the puncturing matrix 580.

Based at least in part on the UE 120 and/or the network node 110 communicating using a MIMO spinal code encoding scheme, the UE 120 and/or the network node 110 may conserve computing, power, network, and/or communication resources that may have otherwise been consumed by communication using MIMO polar code encoding schemes or MIMO LDPC code encoding schemes, among other examples. For example, based at least in part on the UE 120 and/or the network node 110 communicating using a MIMO spinal code encoding scheme, the UE 120 and the network node 110 may communicate with a reduced error rate, which may conserve computing, power, network, and/or communication resources that may have otherwise been consumed to detect and/or correct communication errors.

FIG. 6 is a flowchart illustrating an example process 600 performed, for example, at a transmitter or an apparatus of a transmitter that supports MIMO spinal code encoding schemes in accordance with the present disclosure. Example process 600 is an example where the apparatus or the transmitter (for example, UE 120 or network node 110) performs operations associated with spinal coding schemes for MIMO wireless communications.

As shown in FIG. 6, in some aspects, process 600 may include encoding a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme (block 610). For example, the transmitter (such as by using communication manager 806 or encoding component 809, depicted in FIG. 8 and/or by using communication manager 906 or encoding component 909, depicted in FIG. 9) may encode a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme, as described above.

As further shown in FIG. 6, in some aspects, process 600 may include mapping the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme (block 620). For example, the transmitter (such as by using communication manager 806 or mapping component 810, depicted in FIG. 8 and/or by using communication manager 906 or mapping component 910, depicted in FIG. 9) may map the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme, as described above.

As further shown in FIG. 6, in some aspects, process 600 may include transmitting, using the multiple transmit antennas and the one or more REs, the multiple spinal symbols (block 630). For example, the transmitter (such as by using communication manager 806 or transmission component 804, depicted in FIG. 8 and/or by using communication manager 906 or transmission component 904, depicted in FIG. 9) may transmit, using the multiple transmit antennas and the one or more REs, the multiple spinal symbols, as described above.

Process 600 may include additional aspects, such as any single aspect or any combination of aspects described below or in connection with one or more other processes described elsewhere herein.

In a first additional aspect, mapping the multiple spinal symbols to the multiple transmit antennas is in accordance with a transmit matrix having a size in a first dimension corresponding to a quantity of the multiple transmit antennas and a size in a second dimension corresponding to a quantity of the one or more REs.

In a second additional aspect, alone or in combination with the first aspect, mapping the multiple spinal symbols to the multiple transmit antennas in accordance with the transmit matrix includes mapping the multiple layers to the multiple transmit antennas according to a precoding matrix.

In a third additional aspect, alone or in combination with one or more of the first and second aspects, for each RE, of the one or more REs, a subset of the multiple spinal symbols are sequentially ordered in the transmit matrix in accordance with respective spine indexes associated with the subset of the multiple spinal symbols, and the subset of the multiple spinal symbols includes a quantity of symbols that corresponds to a quantity of the multiple transmit antennas.

In a fourth additional aspect, alone or in combination with one or more of the first through third aspects, the configuration information further indicates a MIMO puncturing scheme associated with the MIMO spinal code encoding scheme, the MIMO spinal code encoding scheme is associated with multiple spines, the MIMO puncturing scheme indicates from which spines, of the multiple spines, spinal symbols are to be transmitted and how to map transmitted spinal symbols to the multiple layers and the one or more REs, and the process 600 further includes mapping the multiple spinal symbols to the multiple layers in accordance with the MIMO puncturing scheme.

In a fifth additional aspect, alone or in combination with one or more of the first through fourth aspects, the MIMO puncturing scheme is associated with selectively transmitting spinal symbols associated with fewer than all spines of the multiple spines.

In a sixth additional aspect, alone or in combination with one or more of the first through fifth aspects, the MIMO puncturing scheme is associated with, for at least one spine of the multiple spines, transmitting multiple spinal symbols associated with the at least one spine.

In a seventh additional aspect, alone or in combination with one or more of the first through sixth aspects, the MIMO puncturing scheme is associated with transmitting a first quantity of spinal symbols associated with a first spine, of the multiple spines, and transmitting a second quantity of spinal symbols associated with a second spine, of the multiple spines, and the first quantity differs from the second quantity.

In an eighth additional aspect, alone or in combination with one or more of the first through seventh aspects, the one or more parameters includes at least one of a quantity of spines associated with the MIMO spinal code encoding scheme, a quantity of the multiple spinal symbols, a quantity of the multiple transmit antennas, a quantity of multiple receive antennas to be used to receive the multiple spinal symbols, a quantity of the multiple layers, a quantity of the one or more REs, or an indication of a MIMO puncturing scheme associated with transmission of the message.

In a ninth additional aspect, alone or in combination with one or more of the first through eighth aspects, the transmitter is associated with a user equipment, and the process 600 further comprises receiving the configuration information.

In a tenth additional aspect, alone or in combination with one or more of the first through ninth aspects, the transmitter is associated with a network node, and the process 600 further comprises transmitting, to a user equipment, the configuration information.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a receiver or an apparatus of a receiver that supports MIMO spinal code encoding schemes in accordance with the present disclosure. Example process 700 is an example where the apparatus or the receiver (for example, network node 110 or UE 120) performs operations associated with spinal coding schemes for MIMO wireless communications.

As shown in FIG. 7, in some aspects, process 700 may include receiving, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme (block 710). For example, the receiver (such as by using communication manager 806 or reception component 802, depicted in FIG. 8 and/or by using communication manager 906 or reception component 902, depicted in FIG. 9) may receive, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme, as described above.

As further shown in FIG. 7, in some aspects, process 700 may include decoding the multiple spinal symbols, resulting in multiple message bits associated with the message (block 720). For example, the receiver (such as by using communication manager 806 or decoding component 812, depicted in FIG. 8 or by using communication manager 906 or decoding component 912, depicted in FIG. 9) may decode the multiple spinal symbols, resulting in multiple message bits associated with the message, as described above.

Process 700 may include additional aspects, such as any single aspect or any combination of aspects described below or in connection with one or more other processes described elsewhere herein.

In a first additional aspect, the multiple spinal symbols are mapped to the multiple receive antennas in accordance with a transmit matrix having a size in a first dimension corresponding to a quantity of the multiple receive antennas and a size in a second dimension corresponding to a quantity of the one or more REs.

In a second additional aspect, alone or in combination with the first aspect, for each RE, of the one or more REs, a subset of the multiple spinal symbols are sequentially ordered in the transmit matrix in accordance with respective spine indexes associated with the subset of the multiple spinal symbols, and the subset of the multiple spinal symbols includes a quantity of symbols that corresponds to a quantity of the multiple receive antennas.

In a third additional aspect, alone or in combination with one or more of the first and second aspects, the configuration information further indicates a MIMO puncturing scheme associated with the MIMO spinal code encoding scheme, the MIMO spinal code encoding scheme is associated with multiple spines, the MIMO puncturing scheme indicates from which spines, of the multiple spines, spinal symbols are to be transmitted and how to map transmitted spinal symbols to the multiple layers and the one or more REs, and the multiple spinal symbols are further mapped to the multiple layers in accordance with the MIMO puncturing scheme.

In a fourth additional aspect, alone or in combination with one or more of the first through third aspects, the MIMO puncturing scheme is associated with receiving spinal symbols associated with fewer than all spines of the multiple spines.

In a fifth additional aspect, alone or in combination with one or more of the first through fourth aspects, the MIMO puncturing scheme is associated with, for at least one spine of the multiple spines, receiving multiple spinal symbols associated with the at least one spine.

In a sixth additional aspect, alone or in combination with one or more of the first through fifth aspects, the MIMO puncturing scheme is associated with receiving a first quantity of spinal symbols associated with a first spine, of the multiple spines, and receiving a second quantity of spinal symbols associated with a second spine, of the multiple spines, and the first quantity differs from the second quantity.

In a seventh additional aspect, alone or in combination with one or more of the first through sixth aspects, the one or more parameters includes at least one of a quantity of spines associated with the MIMO spinal code encoding scheme, a quantity of the multiple spinal symbols, a quantity of multiple transmit antennas to be used to transmit the multiple spinal symbols, a quantity of the multiple receive antennas, a quantity of the multiple layers, a quantity of the one or more REs, or an indication of a MIMO puncturing scheme associated with reception of the message.

In an eighth additional aspect, alone or in combination with one or more of the first through seventh aspects, decoding the multiple spinal symbols includes, for each RE of one or more REs decoding a first spinal symbol, of the multiple spinal symbols, associated with a first receive antenna, of the multiple receive antennas, resulting in a first set of decoded message bits, and decoding a second spinal symbol, of the multiple spinal symbols, associated with a second receive antenna, of the multiple receive antennas, resulting in a second set of decode message bits, wherein decoding the second spinal symbol includes decoding the second spinal symbols using the first set of decoded message bits.

In a ninth additional aspect, alone or in combination with one or more of the first through eighth aspects, decoding the multiple spinal symbols includes decoding the multiple spinal symbols using a multi-dimensional demodulator across the one or more REs.

In a tenth additional aspect, alone or in combination with one or more of the first through ninth aspects, the receiver is associated with a user equipment, and the process 700 further comprises receiving the configuration information.

In an eleventh additional aspect, alone or in combination with one or more of the first through tenth aspects, the receiver is associated with a network node, and the process 700 further comprises transmitting, to a user equipment, the configuration information.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports MIMO spinal code encoding schemes in accordance with the present disclosure. The apparatus 800 may be a UE 120, or a UE 120 may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 140). In some aspects, the communication manager 806 is the communication manager 150.

In some aspects, the apparatus 800 may be configured to and/or operable to perform one or more operations described herein in connection with FIGS. 5A-5C. Additionally or alternatively, the apparatus 800 may be configured to and/or operable to perform one or more processes described herein, such as process 600 of FIG. 6.

The reception component 802 may receive communications, such as reference signals, control information, and/or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the UE 120 described above in connection with FIG. 1, such as a radio, one or more RF chains, one or more transceivers, or one or more modems, each of which may in turn be coupled with one or more antennas of the UE 120.

The transmission component 804 may transmit communications, such as reference signals, control information, and/or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the UE 120 described above in connection with FIG. 1, such as a radio, one or more RF chains, one or more transceivers, or one or more modems, each of which may in turn be coupled with one or more antennas of the UE 120. In some aspects, the transmission component 804 may be co-located with the reception component 802.

The communication manager 806 may encode or may cause the encoding component 808 to encode a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme. The communication manager 806 may map or may cause the mapping component 810 to map the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme. The communication manager 806 may transmit or may cause the transmission component 804 to transmit, using the multiple transmit antennas and the one or more REs, the multiple spinal symbols.

Additionally or alternatively, the communication manager 806 may receive or may cause the reception component 802 to receive, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme. The communication manager 806 may decode or may cause the decoding component 812 to decode the multiple spinal symbols, resulting in multiple message bits associated with the message.

In some aspects, the communication manager 806 may perform one or more operations described elsewhere herein as being performed by one or more components of the communication manager 806.

In some aspects, the communication manager 806 includes a set of components, such as an encoding component 809, a mapping component 810, and/or a decoding component 812. Alternatively, the set of components may be separate and distinct from the communication manager 806. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The encoding component 809 may encode a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme. The mapping component 810 may map the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme. The transmission component 804 may transmit, using the multiple transmit antennas and the one or more REs, the multiple spinal symbols.

The reception component 802 may receive, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme. The decoding component 812 may decode the multiple spinal symbols, resulting in multiple message bits associated with the message.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports MIMO spinal code encoding schemes in accordance with the present disclosure. The apparatus 900 may be a network node 110, or a network node 110 may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 145). In some aspects, the communication manager 906 is the communication manager 155.

In some aspects, the apparatus 900 may be configured to and/or operable to perform one or more operations described herein in connection with FIGS. 5A-5C. Additionally or alternatively, the apparatus 900 may be configured to and/or operable to perform one or more processes described herein, such as process 700 of FIG. 7.

The reception component 902 may receive communications, such as reference signals, control information, and/or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the network node 110 described above in connection with FIG. 1, such as a radio, one or more RF chains, one or more transceivers, or one or more modems, each of which may in turn be coupled with one or more antennas of the network node 110.

The transmission component 904 may transmit communications, such as reference signals, control information, and/or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the network node 110 described above in connection with FIG. 1, such as a radio, one or more RF chains, one or more transceivers, or one or more modems, each of which may in turn be coupled with one or more antennas of the network node. In some aspects, the transmission component 904 may be co-located with the reception component 902.

The communication manager 906 may encode or may cause the encoding component 909 to encode a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme. The communication manager 906 may map or may cause the mapping component 910 to map the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme. The communication manager 906 may transmit or may cause the transmission component 904 to transmit, using the multiple transmit antennas and the one or more REs, the multiple spinal symbols.

The communication manager 906 may receive or may cause the reception component 902 to receive, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme. The communication manager 906 may decode or may cause the decoding component 912 to decode the multiple spinal symbols, resulting in multiple message bits associated with the message.

In some aspects, the communication manager 906 may perform one or more operations described elsewhere herein as being performed by one or more components of the communication manager 906.

In some aspects, the communication manager 906 includes a set of components, such as an encoding component 909, a mapping component 910, and/or a decoding component 912. Alternatively, the set of components may be separate and distinct from the communication manager 906. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The encoding component 909 may encode a message in accordance with configuration information associated with a MIMO spinal code encoding scheme, resulting in a vector that includes multiple spinal symbols, wherein the configuration information includes an indication of one or more parameters associated with the MIMO spinal code encoding scheme and an indication of one or more REs for communicating using the MIMO spinal code encoding scheme. The mapping component 910 may map the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme. The transmission component 904 may transmit, using the multiple transmit antennas and the one or more REs, the multiple spinal symbols.

The reception component 902 may receive, using multiple receive antennas and one or more REs, multiple spinal symbols, wherein the multiple spinal symbols are associated with a message that is encoded in accordance with configuration information associated with a MIMO spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme. The decoding component 912 may decode the multiple spinal symbols, resulting in multiple message bits associated with the message.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method for wireless communication by a transmitter, comprising: encoding a message in accordance with configuration information associated with a multiple input multiple output (MIMO) spinal code encoding scheme, resulting in a vector that includes multiple spinal symbols, wherein the configuration information includes an indication of one or more parameters associated with the MIMO spinal code encoding scheme and an indication of one or more resource elements (REs) for communicating using the MIMO spinal code encoding scheme; mapping the multiple spinal symbols to multiple transmit antennas associated with the transmitter, wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme; and transmitting, using the multiple transmit antennas and the one or more REs, the multiple spinal symbols.

Aspect 2: The method of Aspect 1, wherein mapping the multiple spinal symbols to the multiple transmit antennas is in accordance with a transmit matrix having a size in a first dimension corresponding to a quantity of the multiple transmit antennas and a size in a second dimension corresponding to a quantity of the one or more REs.

Aspect 3: The method of Aspect 2, wherein mapping the multiple spinal symbols to the multiple transmit antennas in accordance with the transmit matrix includes mapping the multiple layers to the multiple transmit antennas according to a precoding matrix.

Aspect 4: The method of Aspect 2, wherein for each RE, of the one or more REs, a subset of the multiple spinal symbols are sequentially ordered in the transmit matrix in accordance with respective spine indexes associated with the subset of the multiple spinal symbols, and wherein the subset of the multiple spinal symbols includes a quantity of symbols that corresponds to a quantity of the multiple transmit antennas.

Aspect 5: The method of any of Aspects 1-4, wherein the configuration information further indicates a MIMO puncturing scheme associated with the MIMO spinal code encoding scheme, wherein the MIMO spinal code encoding scheme is associated with multiple spines, wherein the MIMO puncturing scheme indicates from which spines, of the multiple spines, spinal symbols are to be transmitted and how to map transmitted spinal symbols to the multiple layers and the one or more REs, and wherein the method further comprises mapping the multiple spinal symbols to the multiple layers in accordance with the MIMO puncturing scheme.

Aspect 6: The method of Aspect 5, wherein the MIMO puncturing scheme is associated with selectively transmitting spinal symbols associated with fewer than all spines of the multiple spines.

Aspect 7: The method of Aspect 5, wherein the MIMO puncturing scheme is associated with, for at least one spine of the multiple spines, transmitting multiple spinal symbols associated with the at least one spine.

Aspect 8: The method of Aspect 5, wherein the MIMO puncturing scheme is associated with transmitting a first quantity of spinal symbols associated with a first spine, of the multiple spines, and transmitting a second quantity of spinal symbols associated with a second spine, of the multiple spines, and wherein the first quantity differs from the second quantity.

Aspect 9: The method of any of Aspects 1-8, wherein the one or more parameters includes at least one of: a quantity of spines associated with the MIMO spinal code encoding scheme, a quantity of the multiple spinal symbols, a quantity of the multiple transmit antennas, a quantity of multiple receive antennas to be used to receive the multiple spinal symbols, a quantity of the multiple layers, a quantity of the one or more REs, or an indication of a MIMO puncturing scheme associated with transmission of the message.

Aspect 10: The method of any of Aspects 1-9, wherein the transmitter is associated with a user equipment, and wherein the method further comprises receiving the configuration information.

Aspect 11: The method of any of Aspects 1-10, wherein the transmitter is associated with a network node, and wherein the method further comprises transmitting, to a user equipment, the configuration information.

Aspect 12: A method for wireless communication by a receiver, comprising: receiving, using multiple receive antennas and one or more resource elements (REs), multiple spinal symbols, wherein the multiple spinal symbols are associated with a message that is encoded in accordance with configuration information associated with a multiple input multiple output (MIMO) spinal code encoding scheme, resulting in a vector that includes the multiple spinal symbols, and wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme; and decoding the multiple spinal symbols, resulting in multiple message bits associated with the message.

Aspect 13: The method of Aspect 12, wherein the multiple spinal symbols are mapped to the multiple receive antennas in accordance with a transmit matrix having a size in a first dimension corresponding to a quantity of the multiple receive antennas and a size in a second dimension corresponding to a quantity of the one or more REs.

Aspect 14: The method of Aspect 13, wherein for each RE, of the one or more REs, a subset of the multiple spinal symbols are sequentially ordered in the transmit matrix in accordance with respective spine indexes associated with the subset of the multiple spinal symbols, and wherein the subset of the multiple spinal symbols includes a quantity of symbols that corresponds to a quantity of the multiple receive antennas.

Aspect 15: The method of any of Aspects 12-14, wherein the configuration information further indicates a MIMO puncturing scheme associated with the MIMO spinal code encoding scheme, wherein the MIMO spinal code encoding scheme is associated with multiple spines, wherein the MIMO puncturing scheme indicates from which spines, of the multiple spines, spinal symbols are to be transmitted and how to map transmitted spinal symbols to the multiple layers and the one or more REs, and wherein the multiple spinal symbols are further mapped to the multiple layers in accordance with the MIMO puncturing scheme.

Aspect 16: The method of Aspect 15, wherein the MIMO puncturing scheme is associated with receiving spinal symbols associated with fewer than all spines of the multiple spines.

Aspect 17: The method of Aspect 15, wherein the MIMO puncturing scheme is associated with, for at least one spine of the multiple spines, receiving multiple spinal symbols associated with the at least one spine.

Aspect 18: The method of Aspect 15, wherein the MIMO puncturing scheme is associated with receiving a first quantity of spinal symbols associated with a first spine, of the multiple spines, and receiving a second quantity of spinal symbols associated with a second spine, of the multiple spines, and wherein the first quantity differs from the second quantity.

Aspect 19: The method of any of Aspects 12-18, wherein the one or more parameters includes at least one of: a quantity of spines associated with the MIMO spinal code encoding scheme, a quantity of the multiple spinal symbols, a quantity of multiple transmit antennas to be used to transmit the multiple spinal symbols, a quantity of the multiple receive antennas, a quantity of the multiple layers, a quantity of the one or more REs, or an indication of a MIMO puncturing scheme associated with reception of the message.

Aspect 20: The method of any of Aspects 12-19, wherein decoding the multiple spinal symbols includes, for each RE of one or more REs: decoding a first spinal symbol, of the multiple spinal symbols, associated with a first receive antenna, of the multiple receive antennas, resulting in a first set of decoded message bits; and decoding a second spinal symbol, of the multiple spinal symbols, associated with a second receive antenna, of the multiple receive antennas, resulting in a second set of decode message bits, wherein decoding the second spinal symbol includes decoding the second spinal symbols using the first set of decoded message bits.

Aspect 21: The method of any of Aspects 12-20, wherein decoding the multiple spinal symbols includes decoding the multiple spinal symbols using a multi-dimensional demodulator across the one or more REs.

Aspect 22: The method of any of Aspects 12-21, wherein the receiver is associated with a user equipment, and wherein the method further comprises receiving the configuration information.

Aspect 23: The method of any of Aspects 12-22, wherein the receiver is associated with a network node, and wherein the method further comprises transmitting, to a user equipment, the configuration information.

Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-23.

Aspect 25: An apparatus for wireless communication at a device, the apparatus comprising one or more memories and one or more processors coupled to the one or more memories, the one or more processors configured to cause the device to perform the method of one or more of Aspects 1-23.

Aspect 26: An apparatus for wireless communication, the apparatus comprising at least one means for performing the method of one or more of Aspects 1-23.

Aspect 27: A non-transitory computer-readable medium storing code for wireless communication, the code comprising instructions executable by one or more processors to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

Aspect 29: A device for wireless communication, the device comprising a processing system that includes one or more processors and one or more memories coupled with the one or more processors, the processing system configured to cause the device to perform the method of one or more of Aspects 1-23.

Aspect 30: An apparatus for wireless communication at a device, the apparatus comprising one or more memories and one or more processors coupled to the one or more memories, the one or more processors individually or collectively configured to cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a+a, a +a+a, a +a+b, a+a+c, a +b+b, a +c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitter for wireless communication, comprising:
a processing system that includes one or more processors and one or more memories coupled with the one or more processors, the processing system configured to cause the transmitter to:
encode a message in accordance with configuration information associated with a multiple input multiple output (MIMO) spinal code encoding scheme, resulting in a vector that includes multiple spinal symbols,
wherein the configuration information includes an indication of one or more parameters associated with the MIMO spinal code encoding scheme and an indication of one or more resource elements (REs) for communicating using the MIMO spinal code encoding scheme;
map the multiple spinal symbols to multiple transmit antennas associated with the transmitter,
wherein, to cause the transmitter to map the multiple spinal symbols to the multiple transmit antennas, the processing system is configured to cause the transmitter to distribute the multiple spinal symbols across multiple layers associated with the multiple transmit antennas and across the one or more REs in accordance with the one or more parameters associated with the MIMO spinal code encoding scheme; and
transmit, using the multiple transmit antennas and the one or more REs, the multiple spinal symbols.

2. The transmitter of claim 1, wherein, to cause the transmitter to map the multiple spinal symbols to the multiple transmit antennas, the processing system is configured to cause the transmitter to map the multiple spinal symbols to the multiple transmit antennas in accordance with a transmit matrix having a size in a first dimension corresponding to a quantity of the multiple transmit antennas and a size in a second dimension corresponding to a quantity of the one or more REs.

3. The transmitter of claim 2, wherein, to cause the transmitter to map the multiple spinal symbols to the multiple transmit antennas in accordance with the transmit matrix, the processing system is configured to cause the transmitter to map the multiple layers to the multiple transmit antennas according to a precoding matrix.

4. The transmitter of claim 2, wherein for each RE, of the one or more REs, a subset of the multiple spinal symbols are sequentially ordered in the transmit matrix in accordance with respective spine indexes associated with the subset of the multiple spinal symbols, and
wherein the subset of the multiple spinal symbols includes a quantity of symbols that corresponds to a quantity of the multiple transmit antennas.

5. The transmitter of claim 1, wherein the configuration information further indicates a MIMO puncturing scheme associated with the MIMO spinal code encoding scheme,
wherein the MIMO spinal code encoding scheme is associated with multiple spines,
wherein the MIMO puncturing scheme indicates from which spines, of the multiple spines, spinal symbols are to be transmitted and how to map transmitted spinal symbols to the multiple layers and the one or more REs, and
wherein the processing system is further configured to cause the transmitter to map the multiple spinal symbols to the multiple layers in accordance with the MIMO puncturing scheme.

6. The transmitter of claim 5, wherein the MIMO puncturing scheme is associated with selectively transmitting spinal symbols associated with fewer than all spines of the multiple spines.

7. The transmitter of claim 5, wherein the MIMO puncturing scheme is associated with, for at least one spine of the multiple spines, transmitting multiple spinal symbols associated with the at least one spine.

8. The transmitter of claim 5, wherein the MIMO puncturing scheme is associated with transmitting a first quantity of spinal symbols associated with a first spine, of the multiple spines, and transmitting a second quantity of spinal symbols associated with a second spine, of the multiple spines, and
wherein the first quantity differs from the second quantity.

9. The transmitter of claim 1, wherein the one or more parameters includes at least one of:
a quantity of spines associated with the MIMO spinal code encoding scheme,
a quantity of the multiple spinal symbols,
a quantity of the multiple transmit antennas,
a quantity of multiple receive antennas to be used to receive the multiple spinal symbols,
a quantity of the multiple layers,
a quantity of the one or more REs, or
an indication of a MIMO puncturing scheme associated with transmission of the message.

10. The transmitter of claim 1, wherein the transmitter is associated with a user equipment, and
wherein the processing system is further configured to cause the transmitter to receive the configuration information.

11. The transmitter of claim 1, wherein the transmitter is associated with a network node, and
wherein the processing system is further configured to cause the transmitter to transmit, to a user equipment, the configuration information.

12. A receiver for wireless communication, comprising:
a processing system that includes one or more processors and one or more memories coupled with the one or more processors, the processing system configured to cause the receiver to:
receive, using multiple receive antennas and one or more resource elements (REs), multiple spinal symbols,
wherein the multiple spinal symbols are associated with a message that is encoded in accordance with configuration information that indicates one or more parameters associated with a multiple input multiple output (MIMO) spinal code encoding scheme, resulting in a vector that includes the multiple spinal symbols, and
wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme; and
decode the multiple spinal symbols, resulting in multiple message bits associated with the message.

13. The receiver of claim 12, wherein the multiple spinal symbols are mapped to the multiple receive antennas in accordance with a transmit matrix having a size in a first dimension corresponding to a quantity of the multiple receive antennas and a size in a second dimension corresponding to a quantity of the one or more REs.

14. The receiver of claim 13, wherein for each RE, of the one or more REs, a subset of the multiple spinal symbols are sequentially ordered in the transmit matrix in accordance with respective spine indexes associated with the subset of the multiple spinal symbols, and
wherein the subset of the multiple spinal symbols includes a quantity of symbols that corresponds to a quantity of the multiple receive antennas.

15. The receiver of claim 12, wherein the configuration information further indicates a MIMO puncturing scheme associated with the MIMO spinal code encoding scheme,
wherein the MIMO spinal code encoding scheme is associated with multiple spines,
wherein the MIMO puncturing scheme indicates from which spines, of the multiple spines, spinal symbols are to be transmitted and how to map transmitted spinal symbols to the multiple layers and the one or more REs, and
wherein the multiple spinal symbols are further mapped to the multiple layers in accordance with the MIMO puncturing scheme.

16. The receiver of claim 15, wherein the MIMO puncturing scheme is associated with receiving spinal symbols associated with fewer than all spines of the multiple spines.

17. The receiver of claim 15, wherein the MIMO puncturing scheme is associated with, for at least one spine of the multiple spines, receiving multiple spinal symbols associated with the at least one spine.

18. The receiver of claim 15, wherein the MIMO puncturing scheme is associated with receiving a first quantity of spinal symbols associated with a first spine, of the multiple spines, and receiving a second quantity of spinal symbols associated with a second spine, of the multiple spines, and
wherein the first quantity differs from the second quantity.

19. The receiver of claim 12, wherein the one or more parameters includes at least one of:
a quantity of spines associated with the MIMO spinal code encoding scheme,
a quantity of the multiple spinal symbols,
a quantity of multiple transmit antennas to be used to transmit the multiple spinal symbols,
a quantity of the multiple receive antennas,
a quantity of the multiple layers,
a quantity of the one or more REs, or
an indication of a MIMO puncturing scheme associated with reception of the message.

20. The receiver of claim 12, wherein, to cause the receiver to decode the multiple spinal symbols, the processing system is configured to cause the receiver to, for each RE of one or more REs:
decode a first spinal symbol, of the multiple spinal symbols, associated with a first receive antenna, of the multiple receive antennas, resulting in a first set of decoded message bits; and
decode a second spinal symbol, of the multiple spinal symbols, associated with a second receive antenna, of the multiple receive antennas, resulting in a second set of decode message bits,
wherein, to cause the receiver to decode the second spinal symbol, the processing system is configured to cause the receiver to decode the second spinal symbols using the first set of decoded message bits.

21. The receiver of claim 12, wherein, to cause the receiver to decode the multiple spinal symbols, the processing system is configured to cause the receiver to decode the multiple spinal symbols using a multi-dimensional demodulator across the one or more REs.

22. The receiver of claim 12, wherein the receiver is associated with a user equipment, and
wherein the processing system is further configured to cause the receiver to receive the configuration information.

23. The receiver of claim 12, wherein the receiver is associated with a network node, and
wherein the processing system is further configured to cause the receiver to transmit, to a user equipment, the configuration information.

24. A method for wireless communication by a transmitter, comprising:
encoding a message in accordance with configuration information associated with a multiple input multiple output (MIMO) spinal code encoding scheme, resulting in a vector that includes multiple spinal symbols,
wherein the configuration information includes an indication of one or more parameters associated with the MIMO spinal code encoding scheme and an indication of one or more resource elements (REs) for communicating using the MIMO spinal code encoding scheme;
mapping the multiple spinal symbols to multiple transmit antennas associated with the transmitter,
wherein mapping the multiple spinal symbols to the multiple transmit antennas includes distributing the multiple spinal symbols across multiple layers associated with the multiple transmit antennas and across the one or more REs in accordance with the one or more parameters associated with the MIMO spinal code encoding scheme; and
transmitting, using the multiple transmit antennas and the one or more REs, the multiple spinal symbols.

25. The method of claim 24, wherein mapping the multiple spinal symbols to the multiple transmit antennas is in accordance with a transmit matrix having a size in a first dimension corresponding to a quantity of the multiple transmit antennas and a size in a second dimension corresponding to a quantity of the one or more REs.

26. The method of claim 25, wherein for each RE, of the one or more REs, a subset of the multiple spinal symbols are sequentially ordered in the transmit matrix in accordance with respective spine indexes associated with the subset of the multiple spinal symbols, and
wherein the subset of the multiple spinal symbols includes a quantity of symbols that corresponds to a quantity of the multiple transmit antennas.

27. The method of claim 24, wherein the configuration information further indicates a MIMO puncturing scheme associated with the MIMO spinal code encoding scheme,
wherein the MIMO spinal code encoding scheme is associated with multiple spines,
wherein the MIMO puncturing scheme indicates from which spines, of the multiple spines, spinal symbols are to be transmitted and how to map transmitted spinal symbols to the multiple layers and the one or more REs, and
wherein the method further comprises mapping the multiple spinal symbols to the multiple layers in accordance with the MIMO puncturing scheme.

28. The method of claim 27, wherein the MIMO puncturing scheme is associated with transmitting a first quantity of spinal symbols associated with a first spine, of the multiple spines, and transmitting a second quantity of spinal symbols associated with a second spine, of the multiple spines, and
wherein the first quantity differs from the second quantity.

29. A method for wireless communication by a receiver, comprising:
receiving, using multiple receive antennas and one or more resource elements (REs), multiple spinal symbols,
wherein the multiple spinal symbols are associated with a message that is encoded in accordance with configuration information that indicates one or more parameters associated with a multiple input multiple output (MIMO) spinal code encoding scheme, resulting in a vector that includes the multiple spinal symbols, and
wherein the multiple spinal symbols are mapped to the multiple receive antennas by distributing the multiple spinal symbols across multiple layers associated with the multiple receive antennas and across the one or more REs in accordance with the one or more parameters associated with the MIMO spinal code encoding scheme; and
decoding the multiple spinal symbols, resulting in multiple message bits associated with the message.

30. The method of claim 29, wherein the multiple spinal symbols are mapped to the multiple receive antennas in accordance with a transmit matrix having a size in a first dimension corresponding to a quantity of the multiple receive antennas and a size in a second dimension corresponding to a quantity of the one or more REs.
